(19) United States
(12) Patent Application Publication
(10) Pub. No.: US 2026/0312083 A1
(43) Pub. Date: Oct. 8, 2026

(54) THIN-FILM COMPOSITE MEMBRANES FOR ELECTROCHEMICAL SYSTEMS

(71) Applicant: Massachusetts Institute of Technology, Cambridge, MA (US)

(72) Inventors: Timothy Manning Swager, Newton, MA (US); Zachary Smith, Belmont, MA (US); Taehoon Lee, Cambridge, MA (US); Man Wai Wu, Malden, MA (US)

(73) Assignee: Massachusetts Institute of Technology, Cambridge, MA (US)

(21) Appl. No.: 19/252,343

(22) Filed: Jun. 27, 2025

Related U.S. Application Data
(60) Provisional application No. 63/665,401, filed on Jun. 28, 2024.

(51) Int. Cl. H01M 8/0239; H01M 8/0245; H01M 8/18

(52) U.S. Cl. CPC H01M 8/0239; H01M 8/0245; H01M 8/188

(57) ABSTRACT

Membranes and related applications, including electrochemical systems, are generally described. In some aspects, the membranes are thin-film composite membranes (e.g., formed by interfacial polymerization or otherwise). The membrane, which may include a polymeric selective layer adjacent to a porous support layer, may be configured to be suitable for nonaqueous electrochemical systems (e.g., nonaqueous redox flow batteries) in which relatively low area-specific resistance and relatively lower permeance of redox-active species are desired. In some aspects, the membrane (e.g., as part of its selective layer) includes a cross-linked polymeric network with a relatively high porosity and/or surface area, which may be in part attributed to the use of monomers having three-dimensional structures.

### RELATED APPLICATIONS

This application claims priority under 35 U.S.C. § 119 (e) to U.S. Provisional Patent Application No. 63/665,401, filed Jun. 28, 2024, and entitled “Thin-Film Composite Membranes for Electrochemical Systems,” which is incorporated herein by reference in its entirety for all purposes.

### TECHNICAL FIELD

Membranes and related applications, including electrochemical systems, are generally described.

### SUMMARY

Membranes and related applications, including electrochemical systems, are generally described. The subject matter of the present invention involves, in some cases, interrelated products, alternative solutions to a particular problem, and/or a plurality of different uses of one or more systems and/or articles.

In one aspect, membranes are provided. In some embodiments, the membrane comprises a cross-linked polymeric network comprising a repeat unit derived from a monomer having a three-dimensional structure, wherein the polymeric network has a BET surface area of at least 50 m²/g.

In some embodiments, the polymeric network comprises a polyamide and/or a polyimine.

In some embodiments, the monomer has a three-dimensional structure comprises a non-planar fused bicyclic structure having [2.2.2] or a [2.2.1] ring structure, a triptycene, an iptycene, a calixarene, an adamantane, a tetra-arylmethane, a spiro-arene, and/or a spiro-bisfluorene.

In another aspect, an electrochemical system is provided. In some embodiments, the electrochemical system comprises a cathode compartment comprising a first nonaqueous liquid solution; an anode compartment comprising a second nonaqueous liquid solution; and a membrane separating the cathode compartment and the anode compartment, the membrane comprising: a porous support layer; and a polymeric selective layer adjacent to the porous support layer, the polymeric selective layer having an average thickness of less than or equal to 1 micron. In some embodiments, the polymeric selective layer comprises a polymeric network comprising a repeat unit derived from a monomer having a three-dimensional structure.

In some embodiments, the polymeric selective layer comprises a cross-linked polymeric network comprising a polyamide and/or a polyimine.

In another aspect, methods are provided. In some embodiments, the method comprises charging and/or discharging the electrochemical system.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic illustration of an example of an electrochemical system comprising a cathode compartment and an anode compartment separated by a membrane, in accordance with some embodiments.

FIG. 2 is a cross-sectional schematic illustration of an example of a membrane comprising a polymeric selective layer adjacent to a porous support layer, in accordance with some embodiments.

FIGS. 3A-3B show: (FIG. 3A) Schematic illustration of an example of a NARFB system, according to some embodiments. As an example, vanadium (III) acetylacetonate (V(acac)₃), tetraethylammonium tetrafluoroborate (TEABF₄), and acetonitrile (ACN) were used as redox species, supporting salt, and solvent, respectively; (FIG. 3B) Schematic illustration of conventional membrane configuration for NARFBs; Dense film and porous separator.

FIGS. 4A-4D show: (FIG. 4A) Schematic illustration of examples of methods to fabricate thin-film composite (TFC) membranes using interfacial polymerization; (FIG. 4B) Chemical structure and scanning-electron microscopy (SEM) image of benchmarking crosslinked polyamide (MPD-TMC) membrane. Photo images of (FIG. 4C) roll-to-roll membrane casting machine and (FIG. 4D) a Toray reverse osmosis (RO) membrane module.

FIGS. 5A-5B show: (FIG. 5A) Monomers investigated in Example 1; (FIG. 5B) a permeance-ASR trade-off plot for commercial and lab-made membranes as part of Example 1.

FIG. 6, FIG. 7, FIG. 8, FIG. 9A, FIG. 9B, FIG. 10, FIG. 11, and FIG. 12 show experimental data, properties, and/or chemical structures related to experiments performed using examples of membranes and/or electrochemical systems in accordance with some embodiments.

FIG. 6 shows a diagram indicating the E_{1/2} potentials (versus ferrocenium/ferrocene) of non-limiting examples of organic redox-active species, in accordance with some embodiments.

FIG. 7 shows a diagram indicating the relative order of diameters of non-limiting examples of redox-active species, in accordance with some embodiments.

FIG. 8 shows a plot of calibration data for non-limiting examples of redox-active species, in accordance with some embodiments.

FIG. 9A shows a plot of permeance versus molecular weight for examples of non-limiting redox-active species, in accordance with some embodiments.

FIG. 9B shows a plot of permeance versus simulated diameter for non-limiting redox-active species, in accordance with some embodiments.

FIG. 10 shows a plot of permeance versus simulated diameter for non-limiting redox-active species, in accordance with some embodiments.

FIG. 11 shows a plot of permeance versus simulated diameter for non-limiting redox-active species for different membranes, in accordance with some embodiments.

FIG. 12 shows a synthetic scheme used to generate a membrane, and a plot of area-specific resistance versus permeance of the resulting membrane as compared to other membranes, in accordance with some embodiments.

FIG. 13 shows an example of a scheme for the synthesis of oxacalix[4]arene-based compounds, according to some embodiments.

FIG. 14 shows: an example of a scheme for the synthesis of oxacalix[4]arene-based polyimine ACX-TFB by interfacial polymerization, according to some embodiments.

FIG. 15 shows plots of FTIR spectra of TFB, ACX, ICX and ACX-TFB in their solid state, according to some embodiments.

FIGS. 16A-16B show (FIG. 16A) Nyquist plots of the conductivity of an H-cell containing an electrolyte solution of 0.5 M tetraethylammonium tetrafluoroborate (TEABF) in acetonitrile, with or without the presence of ACX-TFB membrane, according to some embodiments. (FIG. 16B) Area specific resistance (ASR)-permeance plot of commercially available membranes, oxacalix[4]arene-based polyimine ACX-TFB and non-oxacalix[4]arene-based polyimine MPD-TFB; permeance is measured against commercially available catholyte of 10-[2-(2-methoxyethoxy)ethyl]-10H-phenothiazine (MEEPT), according to some embodiments.

FIG. 17 shows examples of possible crosslinking patterns between ACX and TFB to generate the crosslinked polyimine ACX-TFB with their corresponding ratio between oxygen atoms of diaryl ether units (C—O—C) and of remaining aldehyde units (C═O), according to some embodiments. The chemical structure with a ratio of 4:2 for C—O—C to C═O in the box matches closely to the experimentally determined ratio of 4:2.67, in which the additional 0.67 oxygen content is believed to likely represent end groups positioned at the edges of the crosslinked polyimine networks, according to some embodiments.

FIG. 18 shows a plot of cyclic voltammetry of ferrocene in a compartment of an H-cell, the compartment containing 0.5 MⁿEt₄NBF₄ acetonitrile solution with the presence of ACX-TFB membrane, according to some embodiments.

### DETAILED DESCRIPTION

Membranes and related applications, including electrochemical systems, are generally described. In some aspects, the membranes are thin-film composite membranes (e.g., formed by interfacial polymerization or otherwise). The membrane, which may include a polymeric selective layer adjacent to a porous support layer, may be configured to be suitable for nonaqueous electrochemical systems (e.g., nonaqueous redox flow batteries) in which relatively low area-specific resistance and relatively lower permeance of redox-active species are desired. In some aspects, the membrane (e.g., as part of its selective layer) includes a cross-linked polymeric network with a relatively high porosity and/or surface area, which may be in part attributed to the use of monomers having three-dimensional structures.

Nonaqueous redox flow batteries (NARFBs) are an emerging class of energy storage systems featuring high cell voltage, a wide range of operation temperature, and potentially high energy density with low cost. The polymer membrane is a key component to determining efficiencies of NARFBs by allowing fast transport of supporting ions (i.e., low area-specific resistance, ASR) while preventing crossover of redox species (i.e., low permeance). However, developing a fast and selective membrane has been challenging due to the harsh organic solvent environments which will swell or even dissolve a wide range of polymer structures. Aspects of this disclosure are directed to high-performance membranes (e.g., thin-film composite (TFC) membranes) formed by techniques such as in situ interfacial polymerization for electrochemical systems such as NARFBs. It has been observed in the context of this disclosure that, owing at least in part to its ultrathin (~200 nm) and crosslinked structure, at least some embodiments of the membranes prepared according to this disclosure (e.g., some embodiments of TFC membranes) exhibited a very low ASR (<2.3 Ωcm²) coupled with excellent solvent stability compared to those of commercial membranes. Ultimately, it is believed that the developed TFC membranes have great potential to boost the efficiency and cycle life of electrochemical systems such as NARFBs.

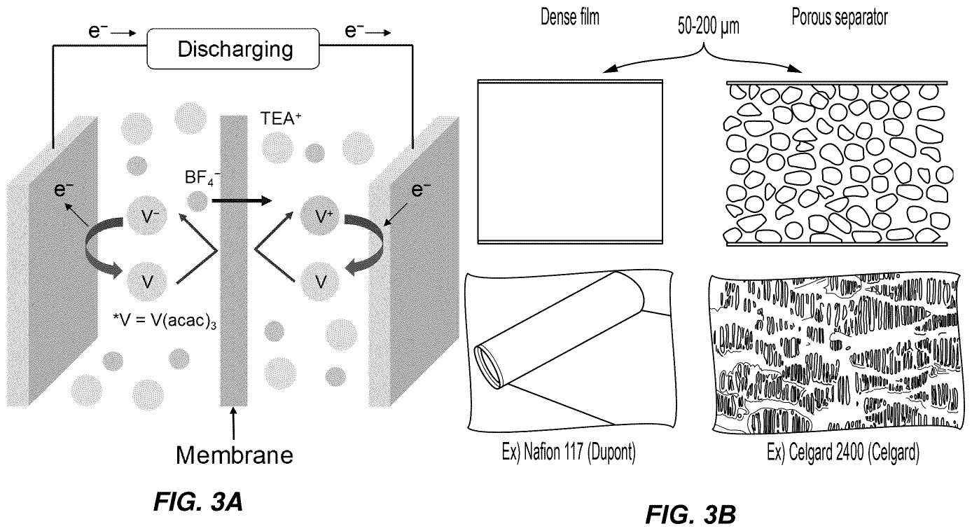

Solar panels and wind turbines are two major renewable energy sources, which are intermittent and not consistently available. To effectively use renewable energy when it is needed, a reliable, sustainable, and efficient storage method is required. One promising solution is the redox flow battery (RFB), which is suitable for grid-scale applications. RFBs comprise an electrochemical flow cell and two reservoirs-one holding an anolyte (a redox-active substance that is reduced during charging) and the other holding a catholyte (a redox-active substance that is oxidized during charging), both dissolved in a solvent with a supporting electrolyte (FIG. 3A). A key advantage of RFBs is their ability to scale power and capacity independently. Power depends on the size of the electrodes and the number of cells, while capacity depends on the volume and concentration of the redox-active molecules in the reservoirs.

However, the economics of storing grid energy based on RFBs still remain challenging. For example, the Department of Energy's Advanced Research Projects Agency-Energy (ARPA-E) has set a capital cost target of $100 per kWh for 1 hour of storage to achieve widespread adoption. The current state-of-the-art commercial RFB is aqueous and utilizes costly vanadium compounds (V²⁺ and V⁵⁺) for the redox-active molecules, resulting in a cost of $300-500 per kWh. Additionally, aqueous RFBs are limited by a small thermodynamic window (1.23 V) due to the hydrogen evolution reaction in reducing environments and the oxygen evolution reaction in oxidizing environments. In contrast, nonaqueous RFBs (NARFBs) offer a larger operating potential window (e.g., ~5 V in acetonitrile), expanding the range of possible redox-active molecules and facilitating higher power densities through larger attainable open circuit voltages (OCV). For example, a proof-of-concept 2.36 V NARFB has been reported in the by Duan, W. et al. ‘wine-dark sea’ in an organic flow battery: Storing negative charge in 2,1,3-benzothiadiazole radicals leads to improved cyclability. ACS Energy Lett 2, 1156-1161 (2017) based on 2,1,3-benzothiadiazole/2,5-di-tert-butyl-1-methoxy-4-[2′-methoxyethoxy]benzene (BzNSN/DBMMB) system, which showcased good cyclability (~160 cycles) with relatively stable efficiencies (~75% of energy efficiency), and capacities (~30 mAh). According to the predictions by Darling, et al. Transport Property Requirements for Flow Battery Separators. J Electrochem Soc 163, A5029-A5040 (2016) the system price of NARFBs could be potentially reduced to $114 per kWh, which is very close to the ARPA-E target, outperforming current aqueous RFB systems.

In addition to the redox-active molecules, the permselective membrane located between the cathode compartment (e.g., comprising a catholyte) and the anode compartment (e.g., comprising an anolyte) may be a key component that determines the energy efficiency of NARFBs. Two of the most important features that it is desirable for the membranes to provide are low area-specific resistance (ASR) and low permeance of redox species (i.e., low crossover). For example, it has been proposed that the ASR and redox species permeance of membranes for NARFBs should be less than 2.3 Ωcm² and 3.0×10⁻⁶ cm s⁻¹, respectively, to meet the system cost target ($120 per kWh according to their scenario). Additionally, high mechanical strength and excellent electrochemical stability are required to achieve stable NARFB performance. Unfortunately, most commercially available dense films/porous separators have been designed for aqueous systems for decades (FIG. 3B), which often exhibit poor separation abilities (i.e., high ASR or high permeance) as well as poor stabilities in the organic solvents to be used for NARFBs. For instance, perfluorosulfonic acid (PFSA) polymers like Nafion are the most common membrane material in aqueous RFBs. However, Nafion shows high ASR in nonaqueous systems (3-9 Ωcm² for Nafion 117), high cost ($500 per m²), and environmental toxicity due to hydrofluoric acid formation during degradation, which are significant drawbacks that hinder its commercial adoption for NARFBs.

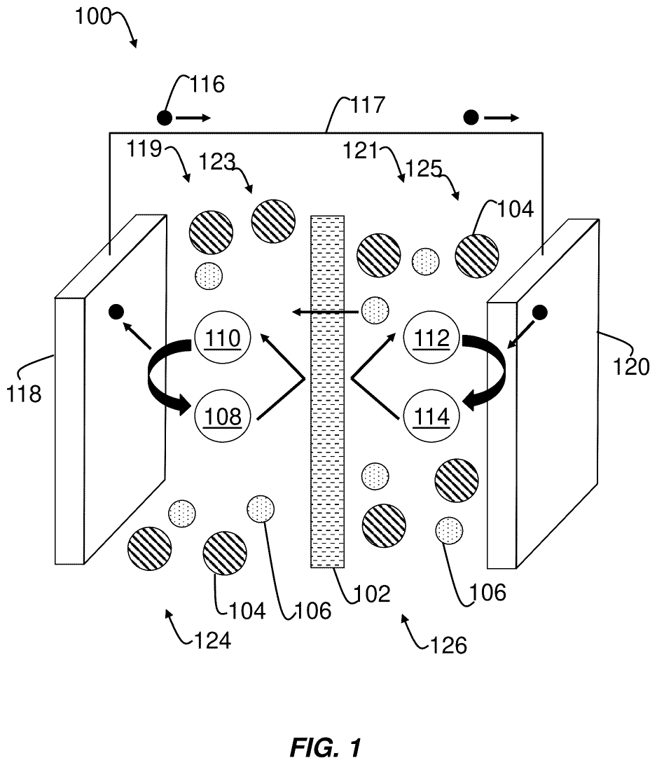

In one aspect, electrochemical systems are provided. FIG. 1 shows a schematic illustration of electrochemical system 100, according to some embodiments. For example, the electrochemical system may comprise an electrochemical cell. The electrochemical cell may be or be part of a battery. For example, the electrochemical system may comprise a redox flow battery.

The electrochemical cell may comprise a cathode compartment. For example, electrochemical system 100 comprises cathode compartment 121, according to some embodiments. The cathode compartment may comprise a first nonaqueous liquid solution (e.g., comprising a catholyte). One or more redox-active species may be at least partially dissolved in the first nonaqueous liquid solution. As an example, in FIG. 1, dissolved redox-active species 112 and 114 are present in cathode compartment 121. In some embodiments, one or more supporting ions is dissolved in the first nonaqueous liquid solution. Referring again to FIG. 1, supporting cation 104 and supporting anion 106 are present in cathode compartment 121. In some embodiments, the cathode compartment further comprises a current collector. In FIG. 1, electrochemical system 100 comprises cathode current collector 120 in contact with the liquid solution comprising redox-active species 112 and 114 and supporting ions 104 and 106 in cathode compartment 121. The cathode compartment may comprise a liquid inlet and/or a liquid outlet. In FIG. 1, cathode compartment 121 comprises cathode inlet 125 and cathode outlet 126.

The electrochemical cell may comprise an anode compartment. For example, electrochemical system 100 comprises anode compartment 119, according to some embodiments. The anode compartment may be separated from the cathode compartment by the membrane. For example, membrane 102 (e.g., a thin-film composite membrane) may separate anode compartment 119 from cathode compartment 121 in electrochemical system 100. The anode compartment may comprise a second nonaqueous liquid solution (e.g., comprising a catholyte). One or more redox-active species (which may be different than those in the cathode compartment) may be at least partially dissolved in the second nonaqueous liquid solution. As an example, in FIG. 1, dissolved redox-active species 108 and 110 are present in anode compartment 119. In some embodiments, one or more supporting ions is dissolved in the second nonaqueous liquid solution. Referring again to FIG. 1, supporting cation 104 and supporting anion 106 are present in anode compartment 119. In some embodiments, the anode compartment further comprises a current collector. In FIG. 1, electrochemical system 100 comprises anode current collector 118 in contact with the liquid solution comprising redox-active species 108 and 110 and supporting ions 104 and 106 in anode compartment 119. The anode compartment may comprise a liquid inlet and/or a liquid outlet. In FIG. 1, anode compartment 119 comprises anode inlet 123 and anode outlet 124.

The cathode compartment and the anode compartment of the electrochemical system may comprise or be configured to receive a first liquid solution and a second liquid solution, respectively. As noted above, in some embodiments, the first liquid solution is a first nonaqueous liquid solution and/or the second liquid solution is a second nonaqueous liquid solution. Any of a variety of nonaqueous liquids may be used. For example, the nonaqueous liquid solution may comprise one or more organic liquids (e.g., acetonitrile) as a solvent. Examples of suitable liquids (e.g., solvents) for the first nonaqueous liquid solution and/or the second liquid solution include, but are not limited to, acetonitrile, nitroethane, 3-methoxypropionitrile, 1,2-butylene carbonate, propylene carbonate, trimethyl phosphate, butyrolactone, methoxyacetonitrile, valerolactone, nitromethane, hexafluoroisopropanol, pyridine, dichloromethane, acetic acid, dimethylsulfoxide, N-methylpyrrolidone, N,N-dimethylformamide, hexamethylphosphoric triamide, tetrahydrofuran, sulfolane, and/or N,N-dimethylacetamide. The choice of nonaqueous liquid may be based on any of a variety of factors, such as desired potential window (e.g., to match redox-active species), ability to dissolve the redox-active species, and/or stability with respect to redox-active species and/or the membrane.

In some embodiments, little to no liquid water is present in the first nonaqueous liquid solution or the second nonaqueous liquid solution (e.g., water is present in an amount of less than or equal to 40 wt %, less than or equal to 25 wt %, less than or equal to 10 wt %, less than or equal to 5 wt %, less than or equal to 2 wt %, less than or equal to 1 wt %, or less by weight of the total liquid). In some embodiments, the first nonaqueous liquid solution has the same liquid composition as the second nonaqueous liquid solution. For example, the first nonaqueous liquid solution and the second nonaqueous liquid solution may comprise acetonitrile as its sole liquid (but in some instances with at least some different dissolved redox-active species present).

In some embodiments, the first nonaqueous liquid solution has a different liquid composition than the second nonaqueous liquid solution. For example, the first nonaqueous liquid solution may comprise a liquid component absent from the second nonaqueous liquid solution (or vice versa), or the first nonaqueous liquid solution may comprise the same liquid components as the second nonaqueous liquid solution but in different relative quantities.

As noted above, in some embodiments, the redox-active species is at least partially dissolved in the first liquid solution and/or the second liquid solution. Other species may also be present in the first liquid solution and/or the second liquid solution. For example, supporting ions may also be present in the first liquid solution and/or the second liquid solution. The supporting ions may comprise a supporting cation and a supporting anion. Any of a variety of supporting ions may be employed and may be chosen based on, for example, solubility in the first liquid solution and/or the second liquid solution, ability for a constituent supporting cation or supporting anion to be transported through the membrane, and/or chemical inertness under the operational conditions of the electrochemical device.

The electrochemical system may be charged and/or discharged. FIG. 1 shows operation of example electrochemical system 100 during a discharging process. During discharging, redox-active species 110 is oxidized in anode compartment 119 to form redox-active species 108, with anode current collector 118 collecting electrons 116. Electrons 116 may be transported along wiring 117 to cathode current collector 120. Electrons received by cathode current collector 120 may be used to reduce redox-active species 112 to redox-active species 114 in cathode compartment 121. Meanwhile, supporting anion 106 may be transported from cathode compartment 121 to anode compartment 119 via membrane 102 to preserve charge neutrality. Membrane 102 may be permselective such that redox-active species 108, 110, 112, and 114 do not pass through membrane 102 or pass through it to a lesser extent than supporting anion 106 (or supporting cation 104). A charging process of electrochemical system 100 would involve the opposite flow of electrons and ions than what is shown in FIG. 1. In some embodiments in which the electrochemical system is operated as a redox flow battery, inlets 123 and 125 and outlets 124 and 126 can be used transport fresh anolyte and catholyte through anode compartment 119 and cathode compartment 121, respectively.

In some embodiments, at least a portion of the first liquid solution (e.g., first nonaqueous liquid solution) is flowed through (and in some instances into and/or out of) at least a portion of the cathode compartment during at least a portion of a charging and/or discharging process of the electrochemical system. In some embodiments, at least a portion of the second liquid solution (e.g., second nonaqueous liquid solution) is flowed through (and in some instances into and/or out of) at least a portion of the anode compartment during at least a portion of a charging and/or discharging process of the electrochemical system.

Any of a variety of redox-active species may be employed in the electrochemical system. The redox-active species may be capable of undergoing one or more reduction and/or oxidation reaction half-reactions (e.g., reversibly) as a result of an applied electrical potential difference across the cathode and anode of the electrochemical system (e.g., within the solvent potential window of the liquid solution in which the redox-active species is present). The redox-active species may be any of a variety of species capable of use in a redox flow battery (e.g., a nonaqueous redox flow battery). The redox-active species may be at least partially (or completely) soluble in the first liquid solution (e.g., first nonaqueous solution) and/or the second liquid solution (e.g., second nonaqueous solution) at at least one temperature (e.g., at least one temperature in the range of greater than or equal to 223 K, greater than or equal to 273 K, greater than or equal to 293 K, greater than or equal to 298 K, and/or up to 323 K, up to 373 K, up to 473 K, up to 573 K, or greater). Combinations of these ranges are possible.

In some embodiments the redox-active species comprise metal ions (e.g., as dissolved metal ions and/or as part of metal coordination complexes). However, in some embodiments, the redox-active species comprises an organic species. Non-limiting examples of redox-active species that may be employed in the electrochemical system include the following (with abbreviations provided for convenience):

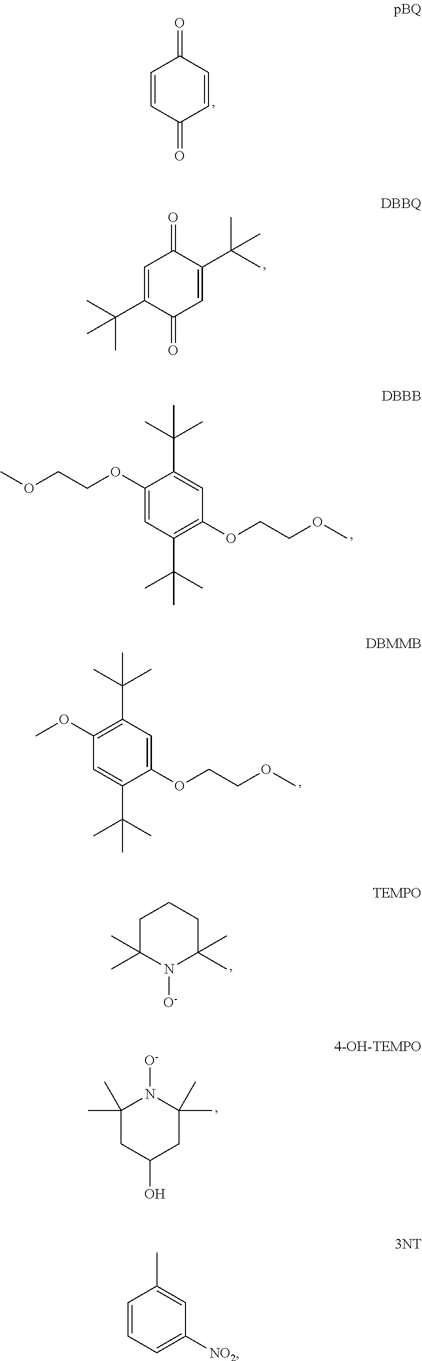

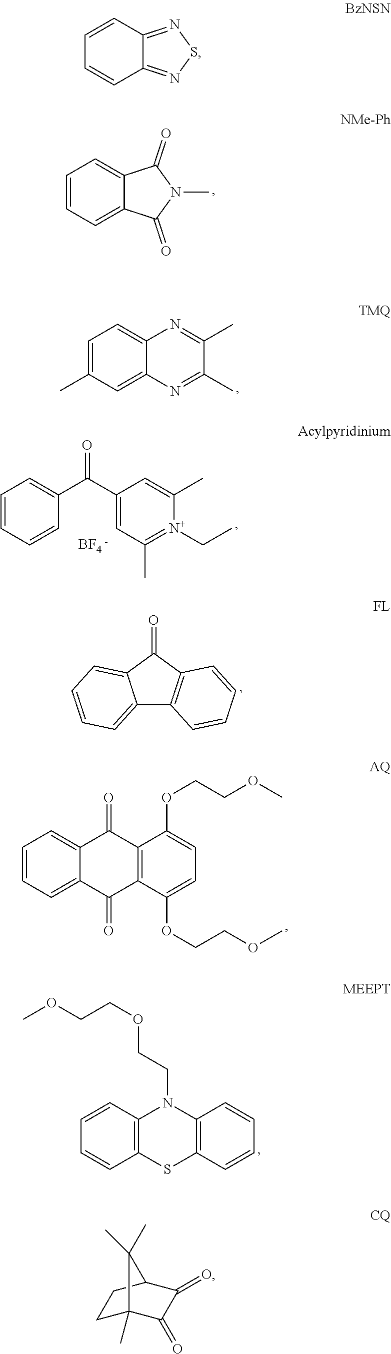

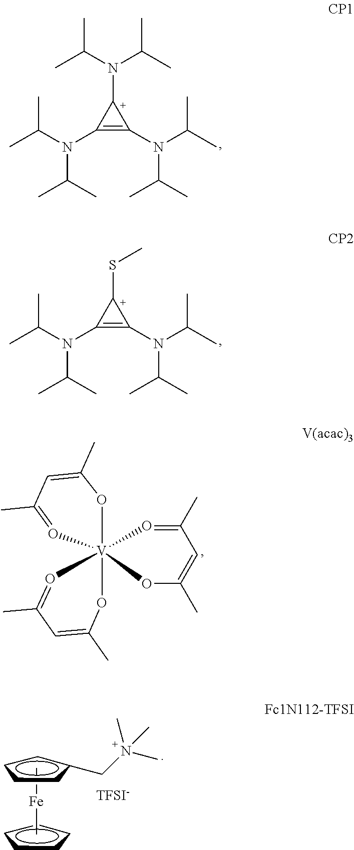

In some embodiments, the pore size and/or pore size distribution of the polymeric selective layer of the membrane discussed in this disclosure is configured such that the membrane can partially or completely block passage of at least some of the redox-active species from the cathode compartment to the anode compartment or vice versa.

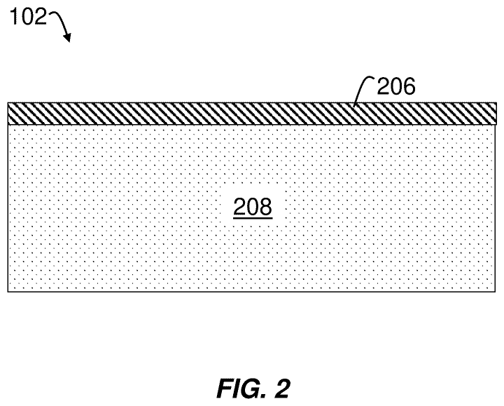

As discussed above, aspects of this disclosure related to membranes. For example, FIG. 2 shows a schematic cross-sectional illustration of membrane 102. In some embodiments, the membrane separates the cathode compartment from the anode compartment of the electrochemical system. As discussed above, FIG. 1 shows membrane 102 separating anode compartment 119 from cathode compartment 121 of electrochemical system 100.

The membrane may permit passage of supporting ions from the cathode compartment to the anode compartment or vice versa, while at least partially (or completely) blocking the passage of one or more redox-active species. In some embodiments, at least a portion of the membrane is in contact (e.g., direct contact) with the first liquid solution (e.g., first nonaqueous liquid solution) in the cathode compartment. In some embodiments, at least a portion of the membrane is in contact (e.g., direct contact) with the second liquid solution (e.g., second nonaqueous liquid solution) in the anode compartment.

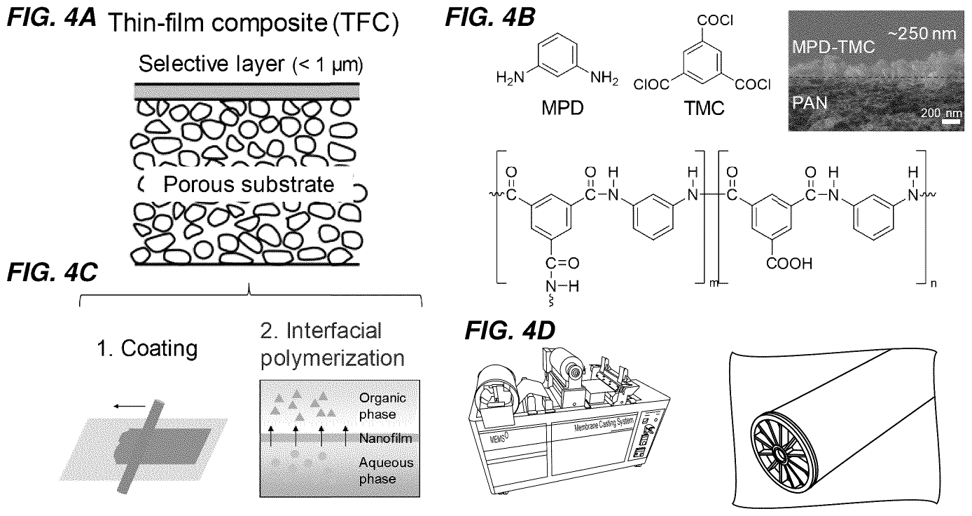

In some embodiments, the membrane is a thin-film composite (TFC) membrane. A thin-film composite membrane is a hybrid configuration of dense selective layer films and porous separators (FIG. 4A). In general, TFC membranes include of a thin selective layer (e.g., having an average thickness of less than or equal to 1 μm) and a porous support layer as a substrate, which may serve to regulate molecular separation and mechanical support, respectively. Any of a variety of techniques may be employed to prepare a TFC membrane. It has been realized that among the fabrication methods for TFC membranes, interfacial polymerization shows certain advantages such as low resistance (ultrathin film) and excellent scalability. These features render the interfacially polymerized TFC membranes to be the most successful commercialization case throughout the membrane history for water purification. Indeed, polyamide TFC membranes prepared by roll-to-roll (R2R) interfacial polymerization of m-phenylenediamine (MPD) and trimesoyl chloride (TMC) monomers have been dominating the current desalination market based on reverse osmosis (FIGS. 4A-4D). Another important advantage of these membranes is that the polymer is already crosslinked, which it has been realized in the context of this disclosure promotes good solvent resistance (e.g., to swelling or dissolution) for molecular separations in nonaqueous environments.

In some embodiments, the membrane comprises a polymeric selective layer. In the embodiment shown in FIG. 2, for example, membrane 102 comprises polymeric selective layer 206.

In some embodiments, the membrane further comprises a porous support layer. For example, in FIG. 2, membrane 102 comprises porous support layer 208. As such, the membrane may be a composite membrane (e.g., a thin-film composite membrane) comprising the polymeric selective layer and the porous support layer. The porous support layer may be adjacent to the polymeric support layer. For example, in FIG. 2, polymeric selective layer 206 is adjacent to porous support layer 208. The porous support layer may be directly adjacent to the polymeric support layer such that no intervening materials are between porous support layer and the polymeric support layer. However, in some embodiments the porous support layer is indirectly adjacent to the polymeric support layer (e.g., such that one or more other layers is between the porous support layer and the polymeric support layer). The porous support layer may provide mechanical support for the membrane while having sufficient porosity such that it does not reduce the overall permeability of the membrane (e.g., with respect to a supporting ion).

The porous support layer may be formed from any of a variety of materials. For example, the porous support layer may comprise a polymer. The polymer of the porous support layer may be different than that of the polymeric selective layer and/or polymeric network or it may be the same (e.g., but with a different porosity and/or crosslinking extent). The material of the porous support layer may be inert with respect to components to which the membrane is to be exposed (e.g., nonaqueous liquids such organic solvents, solute such as ions or neutral molecules). Examples of polymers that the porous support layer may comprise include, but are not limited to, polyethersulfone, polysulfone, polyphenylsulfone, polyvinylidene fluoride, polyacrylonitrile, polypropylene, polytetrafluoroethylene, poly(ether ether ketone), polyimide, cellulose acetate, polycarbonate, polyethylene, and combinations thereof. The porous support layer may be woven or nonwoven. The porous support layer may comprise a single material or multiple different materials. The porous support layer may be a single domain or have multiple domains (e.g., multiple sub-layers).

The porous support layer may be relatively thick as compared to the polymeric support layer. In some embodiments, the porous support layer has a thickness of greater than 1 micron, greater than or equal to 10 microns, greater than or equal to 20 microns, greater than or equal to 30 microns, greater than or equal to 40 microns, greater than or equal to 50 microns, and/or up 100 microns, up to 200 microns, up to 300 microns, or greater. Combinations of these ranges are possible.

In some embodiments, the polymeric selective layer, which may contribute to the selectivity of the membrane (e.g., to one or more redox-active species) may have a relatively low average thickness. For example, the average thickness of the selective layer may be less than or equal to 1 micron, less than or equal to 500 nm, less than or equal to 250 nm, less than or equal to 200 nm, less than or equal to 100 nm, less than or equal to 50 nm, and/or as low as 20 nm, or lower.

In some embodiments, the membrane comprises a cross-linked polymeric network. The polymeric network may form at least a portion (or all) of the polymeric selective layer. The cross-linked polymeric network may comprise linkages. The linkages may connect sub-units (e.g., monomers) and/or polymer chains of the network. The linkages may form such connections via chemical bonds such as covalent chemical bonds. The cross-linked polymeric network may be partially or completely cross-linked.

In some embodiments, the cross-linked polymeric network comprises a repeat unit derived from a monomer having a three-dimensional structure. In other words, the cross-linked polymeric network may be formed by reacting one or more monomers, at least one of which (or all) has a three-dimensional structure. In some embodiments, the repeat unit derived from a monomer having a three-dimensional structure is itself a monomer having a three-dimensional structure. In some embodiments, the repeat unit derived from a monomer having a three-dimensional structure comprises other monomers in addition to a monomer having a three-dimensional structure. For example, the repeat unit may be an oligomer or polymer, at least some monomers of which have a three-dimensional structure. Such oligomers or polymers may then serve as at least some of the repeat units of the cross-linked polymeric network. In some embodiments, the polymer is derived from more than one type of monomer, in which case each monomer may have a three-dimensional structure or one of the monomers may not have a three-dimensional structure. Such a reaction may be performed using interfacial polymerization or a different technique, as described below. In some embodiments, greater than or equal to 30 mole percent (mol %), greater than or equal to 50 mol %, greater than or equal to 75 mol %, greater than or equal to 90 mol %, greater than or equal to 95 mol %, greater than or equal to 98 mol %, greater than or equal to 99 mol %, or all repeat units of the cross-linked polymeric network are derived from a monomer having a three-dimensional structure.

In some embodiments, the monomer having a three-dimensional structure has a contorted, twisted, and/or non-planar geometry. In some embodiments, the monomer having a three-dimensional structure comprises a non-planar fused bicyclic structure having [2.2.2] or a [2.2.1] ring structure, a triptycene, an iptycene, a calixarene, an adamantane, a tetra-arylmethane, a spiro-arene, and/or a spiro-bisfluorene. These monomers may in some but not necessarily all embodiments have any of a variety and/or any of a number of substituents and/or substitutions modifying their base chemical structures. For example, the monomer may comprise a bulky group substituent such as tert-butyl groups to contribute to steric hindrance, reactive functional groups such as amine groups to promote formation of linkages, and/or halo groups such as fluoro groups. The three-dimensional structure may promote porosity (e.g., intrinsic porosity) for the resulting polymeric network. In some embodiments, the three-dimensional monomer has at least two (e.g., at least three, or more) reactive functional groups.

In some embodiments, the monomer having a three-dimensional structure comprises a macrocyclic structure. One non-limiting example is a calixarene. Any of a variety of calixarenes may be employed, such as but not limited to a calix[n]arene and/or an oxacalix[4]arene, where n=4, 6, or 8.

In some embodiments in which the polymeric network comprises linkages, at least some of the linkages are nitrogen-containing linkages. Nitrogen-containing linkages may comprise organic functional groups that include at least one nitrogen atom. For example, the nitrogen-containing linkages may comprise as an amine group, an amide group, an imine group, an imide group, an amidine group, a carbamate group, an oxime group, a sulfonamide group, a diazo group, and/or a Tröger's base. In some embodiments, the polymeric network comprises a polyamine, a polyamide and/or a polyimine. In some embodiments, the polymeric network comprises a polyamide and/or a polyimine.

The cross-linked polymeric network (e.g., of the selective layer) may have any of a variety of chemical structures. In some embodiments, at least a portion of the polymer network comprises one or more of the following chemical structures:

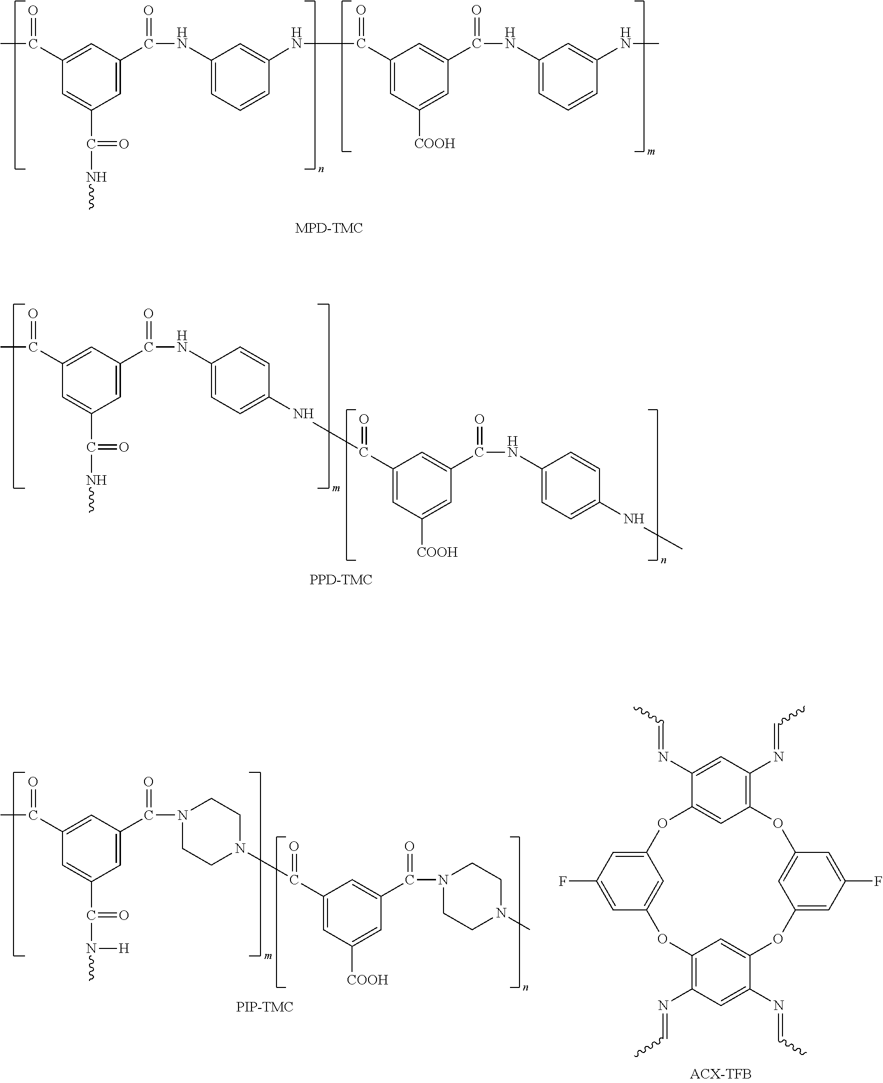

In some embodiments, the polymeric network has a relatively high surface area, which may be associated with a relatively high porosity. In some embodiments, the polymeric network has a Brunauer-Emmett-Teller (BET) surface area of at least 50 m²/g, at least 100 m²/g, at least 200 m²/g, at least 500 m²/g, at least 1000 m²/g, at least 2000 m²/g, and/or up to 3000 m²/g, or greater. In some embodiments, the polymeric network has a Brunauer-Emmett-Teller (BET) surface area of less than or equal to 3000 m²/g, less than or equal to 2000 m²/g, less than or equal to 1500 m²/g, less than or equal to 1000 m²/g, less than or equal to 800 m²/g, or less. Combinations of these ranges are possible. The BET surface area may be measured using a probe gas (e.g., carbon dioxide) at, for example, a temperature of 273 K.

In some embodiments, at least portion of the polymer network has intrinsic porosity. For example, in some embodiments, at least a portion of the polymer network comprises a polymer of intrinsic porosity. Intrinsically porous (e.g., microporous) regions of the polymer network may contain a continuous network of interconnected voids (e.g., less than 2 nm in width) generated from, for example, the underlying rigid and contorted structure of the polymer chains (e.g., as opposed to external additives). The intrinsic porosity may contribute to free volume permitting beneficial performance the resulting membrane as a separator in an electrochemical system. Moreover, the presence of a network polymer in the polymeric selective layer (e.g., from crosslinking repeat units derived from monomers with a three-dimensional structure) may reduce or prevent swelling in the presence of nonaqueous liquids such as organic liquids. The mitigated swelling may be beneficial for applications such as nonaqueous electrochemical systems such as nonaqueous redox flow batteries.

In some embodiments, the polymeric network (e.g., of the selective layer) is formed by interfacial polymerization. In this context, the interface corresponds to the region where the polymer is formed. An interface may be formed between two immiscible solutions, e.g., as is the case for oil and water. The interface may be between a liquid and vapor, where one monomer-containing composition is delivered to the interface from the liquid and another monomer-containing solution is from a vapor. The interface may also be between a monomer-containing composition and a gas atmosphere where a second monomer-containing composition is delivered from the gas atmosphere in the form of particles. The interface may be produced between miscible fluids by the use of, for example, a semipermeable barrier, where other solutions on either side of the barrier contain a monomer-containing composition that react with each other, e.g., with concurrent diffusion through the barrier.

Aspects of this disclosure are directed to the development of fluorine-free, high-performance TFC membranes by interfacial polymerization for nonaqueous electrochemical system (e.g., NARFB) applications. Various of such aspects involve molecular engineering strategies based on, for example, micropore-generating units to develop structure-property correlations for the discovery of material candidates. In addition, some aspects relate to identifying advantageous redox couples and electrolytes to develop membranes whose performance can be evaluated by, for example, performing cycling tests of the electrochemical system.

U.S. Provisional Patent Application No. 63/665,401, filed Jun. 28, 2024, and entitled “Thin-Film Composite Membranes for Electrochemical Systems,” is incorporated herein by reference in its entirety for all purposes.

The following examples are intended to illustrate certain embodiments of the present invention, but do not exemplify the full scope of the invention.

### Example 1

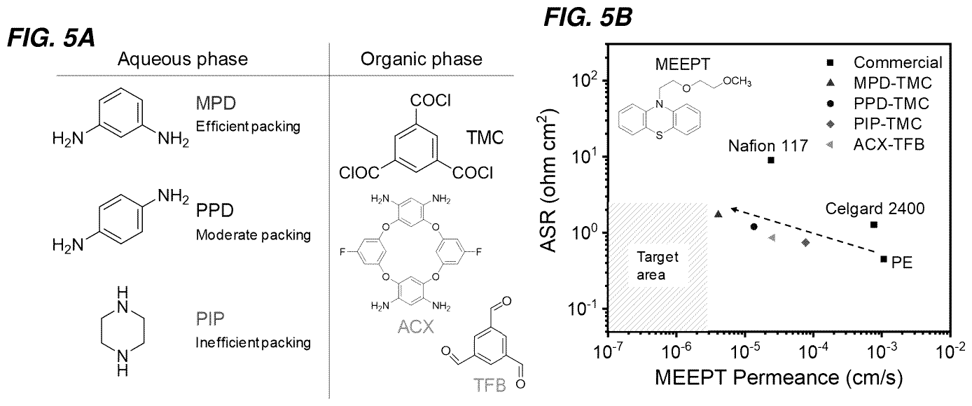

This Example describes experiments related to the development of an interfacially polymerized TFC membrane that addresses at least some of the current challenges of developing advanced and scalable membranes for NARFBs. FIG. 5A lists the monomers used for the preliminary studies to prepare polyamide TFC membranes by interfacial polymerization. In addition to MPD and TMC, p-phenylenediamine (PPD) and piperazine (PIP) were also investigated to tune the molecular packing structure of the resultant membranes, which have been reported for desalination applications. Also, amino-calixarene (ACX) and triformylbenzene (TFB) were used as a macrocycle and organic linker, respectively, to prepare another type of TFC membrane based on polyimine chemistry.

FIG. 5B highlights the potential of our molecular engineering concept. Here, 10-[2-(2-Methoxyethoxy)ethyl]-10H-phenothiazine (MEEPT) was used as a representative organic redox species while TEABF₄ and acetonitrile was used as a solvent and supporting salt, respectively, since these chemicals have been widely used in NARFB studies. The transport properties of the polyamide membranes were successfully tuned depending on which diamine monomer was used. In particular, the ASR and permeance of the MPD-TMC membrane are almost close to the target area, which outperforms the current state-of-the-art commercial membranes such as Nafion 117 (Dupont), Celgard 2400 (Asahi Kasei), and polyethylene (PE, SK Innovation). The results clearly demonstrate the effectiveness of the integration of two strategies—(1) interfacially polymerized TFC membranes and (2) their molecular engineering-towards advanced NARFB membranes.

### Methods

### Summary of TFC Membranes from this Example

TABLE 1

| | | | | | | Area-specific |
|---|---|---|---|---|---|---|
| | | | | | Permeance | resistance |
| Chemistry | Method | Configuration | Substrate | Thickness | (cm s⁻¹)⁴⁾ | (ASR, ohm cm²)⁵⁾ |
| MPD-TMC | Ip¹⁾ | TFC²⁾ | PE³⁾ | 0.002 | 4.08 × 10⁻⁶ | 1.72 |
| PPD-TMC | | | | | 1.36 × 10⁻⁵ | 1.20 |
| PIP-TMC | | | | | 7.71 × 10⁻⁵ | 0.74 |
| ACX-TFB | | | | | 2.55 × 10⁻⁵ | 0.86 |

¹⁾IP: Interfacial polymerization
²⁾TFC: Thin-film composite
³⁾PE: Polyethylene, 20 μm, Minihua store (China), irradiated with O₂ plasma (20 W and 20 s).
⁴⁾Measured using a TEABF₄ 0.1M/MEEPT 0.01M/Acetonitrile solution
⁵⁾Measured using a TEABF₄ 0.5M/Acetonitrile solution

### Preparation of TFC Membranes

### Materials

m-Phenylenediamine (MPD, 99%), p-phenylenediamine (PPD, 98%), piperazine (PIP, 99%), triformylbenzene (TFB, 97%), trimesoyl chloride (TMC, 98%) were purchased from Sigma Aldrich (USA). Amino calixarene (ACX) was kindly provided by Swager Lab (MIT, USA).

### Polyamide TFC Membranes (MPD-TMC, PPD-TMC, and PIP-TMC)

TMC-based polyamide TFC membranes were prepared by in situ interfacial polymerization on a porous PE support. Initially, a 5×5 cm²-sized polyethylene (PE) substrate (Minihua store, China) was hydrophilized by oxygen plasma treatment (20 W and 20 s). The PE substrate was immersed in IPA for 1 min and washed with DI water. The pretreated PE substrate was fixed on a glass plate with a Teflon frame and an aqueous solution containing each diamine monomer (MPD (2 w/v %), PPD (1 w/v %), and PIP (1 w/v %)) was poured onto the support. After 1 min, the diamine solution was removed, and the residual water droplets were removed using a rubber roller. Subsequently, 0.1 w/v % of TMC solution was poured onto the diamine-soaked PE substrate, and the reaction proceeded for 1 min at room temperature. After the reaction, the excess TMC solution was washed with hexane. The prepared TFC membranes were subsequently washed with DI water several times and stored in an acetonitrile bath before permeation tests.

### Polyimine TFC Membranes (ACX-TFB)

ACX-TFB membrane was prepared by in situ interfacial polymerization on a porous PE support. Initially, a 5×5 cm²-sized PE substrate was hydrophilized by oxygen plasma treatment (20 W and 20 s). The PE substrate was immersed in IPA for 1 min and washed with DI water. The pretreated PE substrate was fixed on a glass plate with a Teflon frame and an acetic acid/water mixture (1:2, by volume) was poured onto the support. After 1 min, the aqueous solution was removed, and the residual water droplets were removed using a rubber roller. Subsequently, a mixture of ACX and TFS in dichloromethane (DCM, 0.4 mg/mL for each component) was poured onto the water-soaked PE substrate, and the reaction proceeded for 90 min at room temperature. After the reaction, the excess solution was washed with pure DCM. The prepared TFC membranes were subsequently washed with DI water several times and stored in an acetonitrile bath before permeation tests.

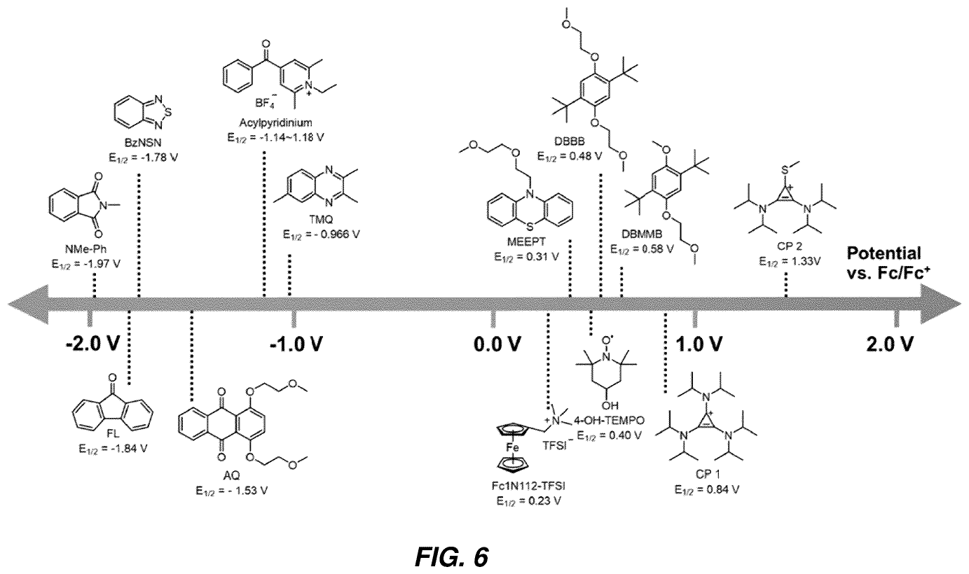

Results from further experimentation are shown in FIGS. 6-12.

FIG. 6 shows a diagram indicating the E_{1/2} potentials (versus ferrocenium/ferrocene) of non-limiting examples of organic redox-active species that can be employed in nonaqueous redox flow batteries comprising the membranes described in this disclosure, in according with some embodiments. It has been realized in the context of this disclosure that, in contrast to transition metal salts, organic redox-active species are often composed of earth-abundant elements and in many instances can be synthesized via sustainable and low-cost materials.

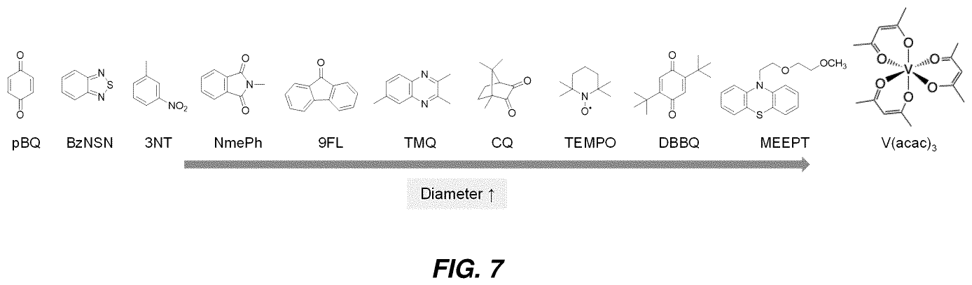

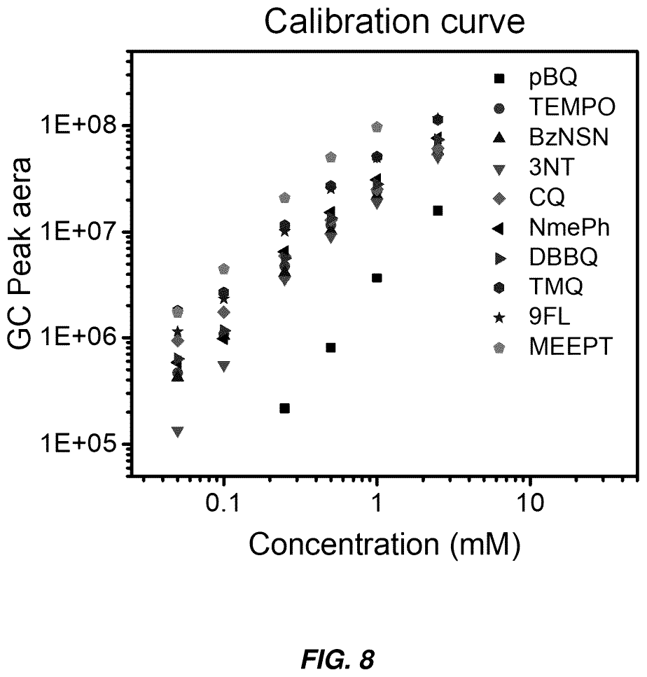

FIG. 7 shows a diagram indicating the relative order of diameters of non-limiting examples of redox-active species that can be employed in electrochemical systems such as nonaqueous redox flow batteries comprising the membranes described in this disclosure, in according with some embodiments. These particular redox-active species were investigated for use of electrochemical systems such as nonaqueous redox flow batteries (NARFBs) because they are soluble in acetonitrile, are commercially available, have different boiling points (which allows them to be detected and distinguished by gas chromatography (GC)), have different molecular weights (and sizes) and different reduction potentials. Table 2 provides boiling point, molecular weight, simulated diameter, and reduction potentials for the species shown in FIG. 7.

TABLE 2
Tabulated parameters for examples of redox-active species.

| | | Boiling | Molecular | Simulated diameter | |
|---|---|---|---|---|---|
| | | point | weight | (Å) | Potential |
| Full name | Abbreviation | (° C.) | (g mol⁻¹) | by ChemDraw 3D | (vs Fc/Fc⁺, V)^{[Ref]} |
| p-BENZOQUINONE | pBQ | 293 | 108.10 | 5.28 | 0.37 |
| 2,1,3-Benzothiadiazole | BzNSN | 206 | 136.17 | 5.61 | −1.78 |
| 3-Nitrotoluene | 3NT | 230 | 137.14 | 5.90 | −2.04 |
| N-methylphthalimide | NMePh | 286 | 161.16 | 6.26 | −1.97 |
| 9-Fluorenone | 9FL | 342 | 180.20 | 6.37 | −1.84 |
| 2,3,6-Trimethylquinoxaline | TMQ | 277 | 172.23 | 6.56 | −0.97 |
| Camphorquinone | CQ | 234 | 166.22 | 6.74 | −1.80 |
| TEMPO | TEMPO | 193 | 156.25 | 6.90 | 0.25 |
| 2,5-Di-tert-butyl-1,4- | DBBQ | 321 | 220.31 | 7.47 | N/A |
| benzoquinone | | | | | |
| 10-[2-(2- | MEEPT | 439 | 301.40 | 7.80 | 0.31 |
| Methoxyethoxy)ethyl]- | | | | | |
| 10H-phenothiazine | | | | | |
| Vanadium(III) | V(acac)₃ | N/A | 348.27 | 8.05 | 0.36 |
| acetylacetonate | | | | | |

^{[Ref]}Electrochim. Acta 113, 127-133 (2013) / J. Phys. Chem. C 124, 24105-24114 (2020)

GC measurements for the organic redox-active species from FIG. 7 were conducted, with calibration measurements shown in FIG. 8 and fit error indicated in Table 3 below. As can be seen in FIG. 8, the redox-active species tested have different GC peaks, indicated a wide range of properties across the set of redox-active species.

TABLE 3
Linear regression error for GC calibration
of examples of redox-active species.

| | Molecular | Simulated | R² |
|---|---|---|---|
| | weight | diameter (Å) | (linear |
| Abbreviation | (g mol⁻¹) | by ChemDraw 3D | regression) |
| pBQ | 108.10 | 5.28 | 0.987 |
| BzNSN | 136.17 | 5.61 | 0.999 |
| 3NT | 137.14 | 5.90 | 0.999 |
| NmePh | 161.16 | 6.26 | 0.999 |
| 9FL | 180.20 | 6.37 | 0.999 |
| TMQ | 172.23 | 6.56 | 0.999 |
| CQ | 166.22 | 6.74 | 0.999 |
| TEMPO | 156.25 | 6.90 | 0.995 |
| DBBQ | 220.31 | 7.47 | 0.998 |
| MEEPT | 301.40 | 7.80 | 0.998 |

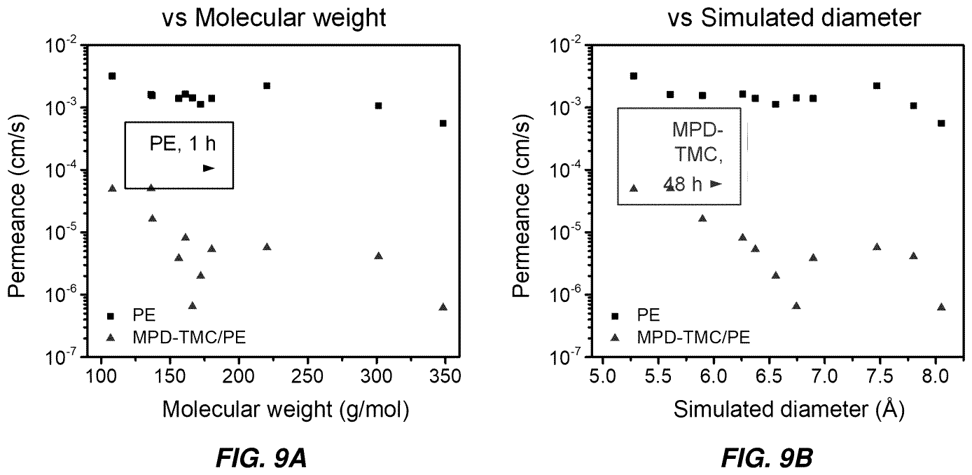

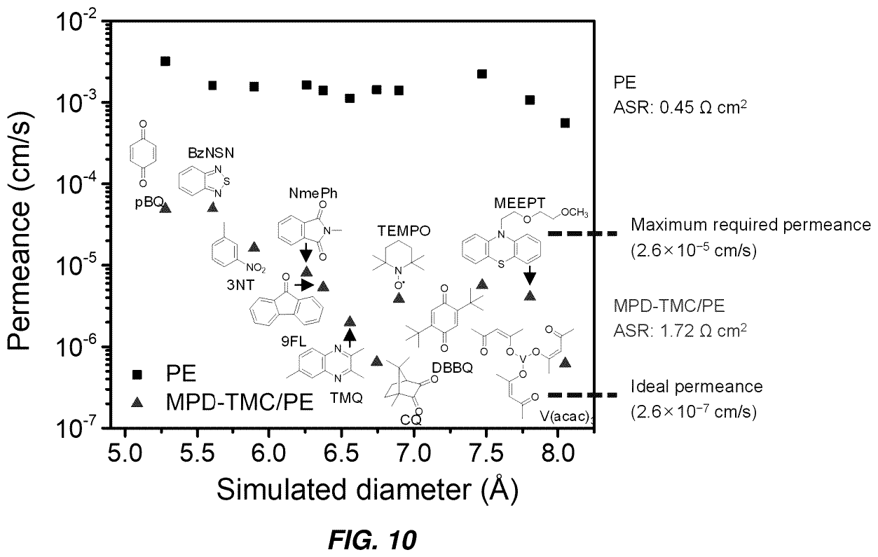

The permeance of a polyethylene porous support layer (PE) and an example of a thin-film composite membrane (MPD-TMC/PE) with respect to the redox-active species from FIG. 7 were tested using a 10-component mixture that included 10 different redox-active species from FIG. 7 at 0.01 M for each donor component and in 0.1 M tetraethylammonium tetrafluoroborate (TEABF₄)/acetonitrile electrolyte in an H-cell. The other compartment contained 0.2 M TEABF₄/acetonitrile. FIG. 9A shows a plot of the permeance versus molecular weight for the redox-active species investigated. FIG. 9B shows a plot of the permeance versus simulated diameter for the redox-active species investigated. To measure the permeance, the concentrations of the organic redox-active species were measured by GC, while the concentrations of V(acac)₃ were measured by UV-vis spectrophotometry. FIG. 10 shows the permeance versus simulated diameter plot with structures of the tested redox-active species for each data point, along with an indicated of the ASR for each membrane along with annotations for examples of requirements for permeance and an ideal permeance for certain applications.

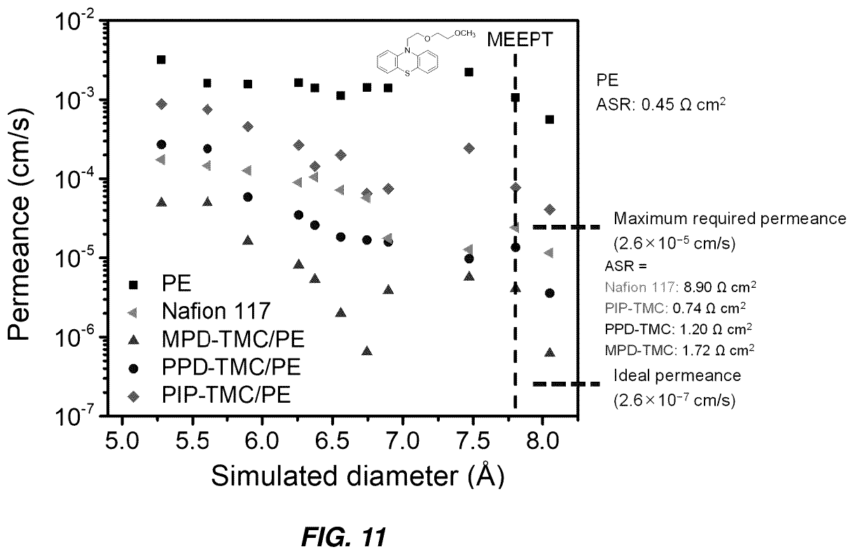

FIG. 11 shows a plot of permeance versus simulated diameter of redox-active species for a wider variety of membranes, including PE, Nafion 117, MPD-TMC/PE, PPD-TMC/PE, and PIP-TMC/PE, along with ASR values. The experiment was run under similar conditions to FIGS. 9A, 9B, and 10.

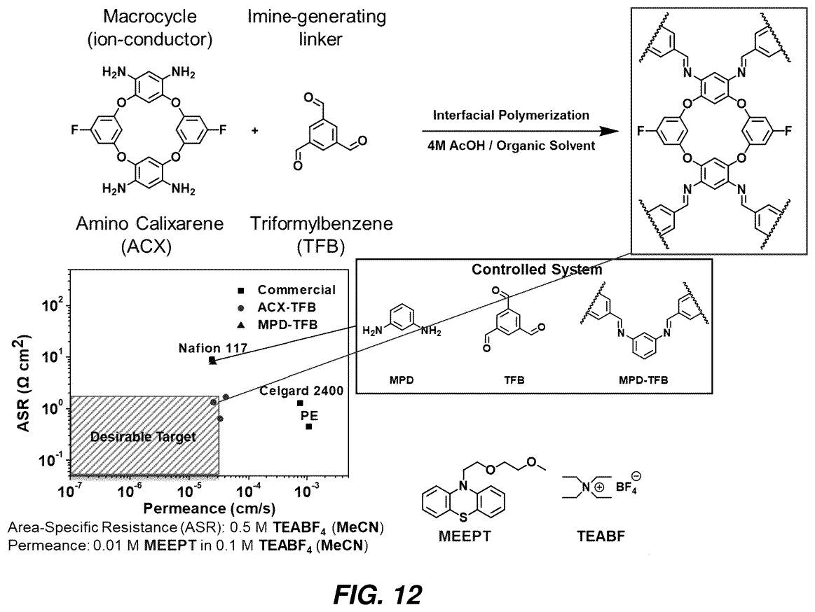

FIG. 12 shows a synthetic scheme used to generate the amino calixarene-based selective layer membrane and a plot of area-specific resistance versus permeance of the resulting membrane versus other membranes with MEEPT as the tested redox-active species.

### Example 2

This Example describes experiments related to the development of an example interfacially polymerized TFC membrane and its use in an electrochemical system, according to some embodiments.

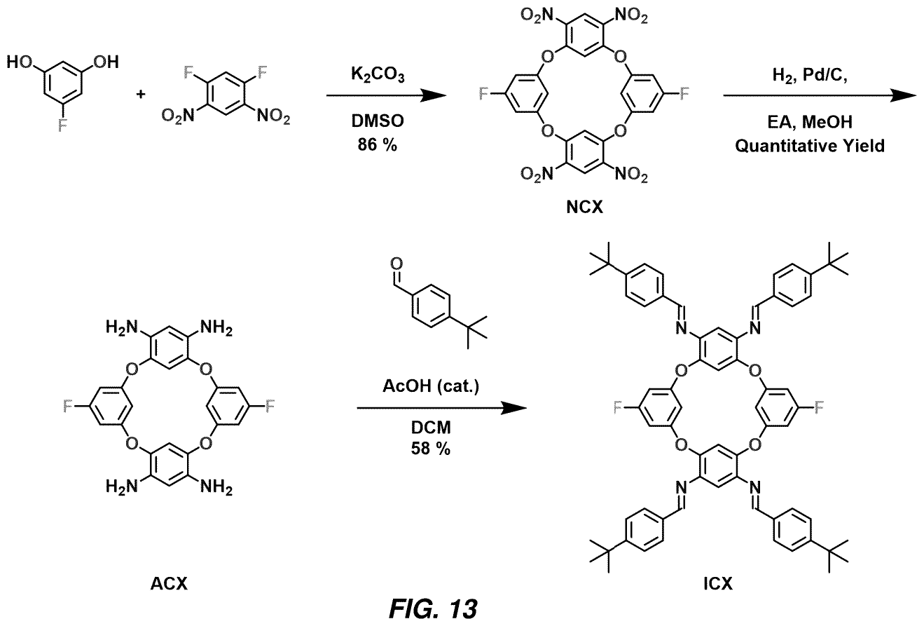

Synthesis and Characterization. The tetranitro-oxacalix[4]arene NCX with a macrocyclic scaffold and intrinsic pore was first obtained by a four-fold S_{N}Ar reaction of 5-fluorobenzene-1,3-diol and 1,5-difluoro-2,4-dinitrobenzene at room temperature (FIG. 13). Subsequently, the tetraamino-oxacalix[4]arene ACX was prepared, as a monomer for the generation of crosslinked polyimine, by a palladium on carbon (Pd/C) catalyzed hydrogenation of NCX in a quantitative yield. ACX was simply obtained by filtration of solution to remove Pd/C without further purification of column chromatography. The electron-rich ACX with four amine units was found to be very stable under ambient condition for at least several months as pale pink solids while tetraamino-oxacalix[4]arene-based compounds were found to undergo decomposition in the presence of oxygen. It is believed that two electron-withdrawing fluoro substitutes can help stabilization of the oxacalix[4]arene ring connecting with four electron-rich amine units. A model imine compound of tetraimino-oxacalix[4]arene ICX was also synthesized by the acid catalyzed four-fold condensation reaction of ACX with 4-(tert-butyl)benzaldehyde. Similarly, ICX was found to be stable and was isolated under ambient condition as yellow solids. With this synthetic method, multiple nitro can be fully transformed to amine and finally to imine groups on an oxacalix[4]arene backbone.

The oxacalix[4]arene compounds NCX, ACX and ICX were structurally characterized using ¹H, ¹³C{¹H} and ¹⁹F{¹H} NMR spectroscopy, HR-DART-MS and HR-MALDI-MS. Upon reduction of the nitro groups in NCX, all ¹H signals of aromatic protons on oxacalix[4]arene ring displayed significantly upfield shifts from 8.94-7.03 ppm to 6.59-5.78 ppm in the ¹H NMR spectrum of ACX. Meanwhile, a new emergence of a ¹H singlet signal located at 4.60 ppm with an integral of 8 protons was observed, indicating a complete conversion of four nitro to amine groups. Furthermore, the ¹H signal of the amine in ACX vanished completely with a new appearance of ¹H signals at 1.33 and 8.41 ppm, which were attributed to tert-butyl group and imine unit, respectively, during the formation of the model imine compound ICX. Single co-crystals of monomer ACX associated with two acetone as solvent molecules held together by hydrogen bonding pairs were obtained as colorless triclinic crystals and characterized by X-ray crystallographic analysis (CCDC: 2373868; Table 4). The tetraamino-oxacalix[4]arene scaffold of ACX adopted a twisted-1,3-alternate conformation with pseudo-C₂ᵥ symmetry, in which two phenyl rings with two amine units were almost eclipsed by each other. Within the intrinsic pore, distances between two phenyl rings with two amine units and two phenyl rings with fluorine unit were found to be 4.845 Å and 4.652 Å, respectively.

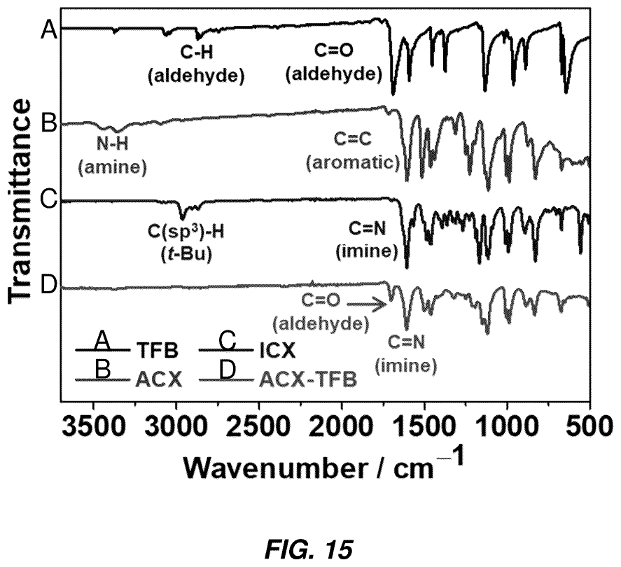

Fourier-transform infrared spectroscopy (FTIR) was employed to gain deeper insight in the chemical structure of crosslinked oxacalix[4]arene-based polyimine ACX-TFB prepared by interfacial polymerization (IP). With the comparison of amine-containing oxacalix[4]arene ACX, the typical amino signals of respective symmetric and asymmetric N—H stretching at ca. 3358 cm⁻¹ and ca. 3442 cm⁻¹ completely vanished in ACX-TFB (FIG. 15), suggesting the full consumption of all amine units during the acid-catalyzed condensation polymerization between ACX and TFB, in which the disappearance of amine signals well matched with the FTIR spectrum of the model imine compound ICX. Moreover, the typical aldehyde signal of C═O stretching at ca. 1701 cm⁻¹ in TFB remained but exhibited much less intensity in ACX-TFB, indicative of the presence of aldehyde groups within crosslinking networks of polyimine. The imine signals of C═N stretching at ca. 1608 cm⁻¹ in ICX and ACX-TFB, however, were believed to be probably mixed with signals of aromatic sp² C═C ring stretching. In addition, the crosslinked polyimine ACX-TFB appeared as a yellow membrane, which drove the investigation of the photophysical properties of the model imine compound ICX using UV-vis absorption spectroscopy. In contrast to TFB and ACX, which absorb light mainly in UV region, it was observed that ICX appeared as a pale-yellow powder and exhibited the lowest-energy absorption tail of visible violet light covering at ca. 380-400 nm in DCM, which is believed to be likely attributed to the π-π* transition along the extended π-conjugation of bis-imine moiety upon condensation reaction with the generation of π-conjugated imine linkages. This is also believed to explain the fact that ACX-TFB appeared as enriched and more red-shifted yellow color because of the formation of multiple π-conjugated imine linkages within the crosslinked polymer network.

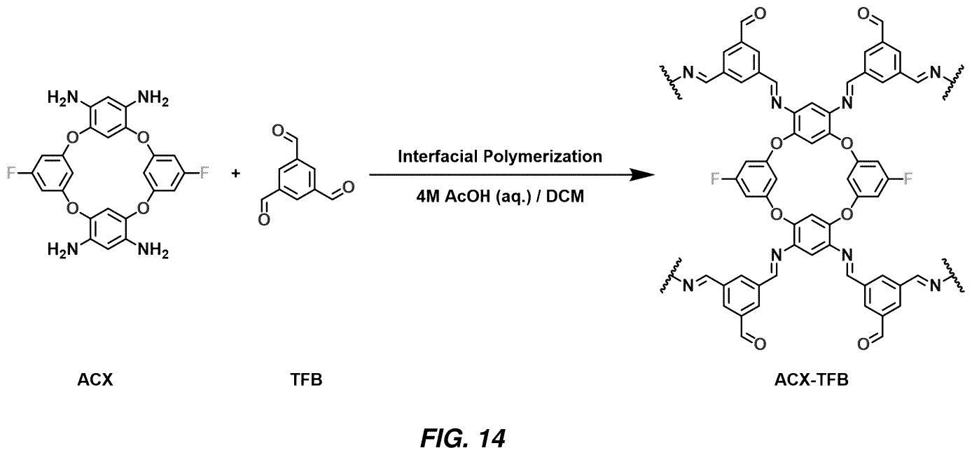

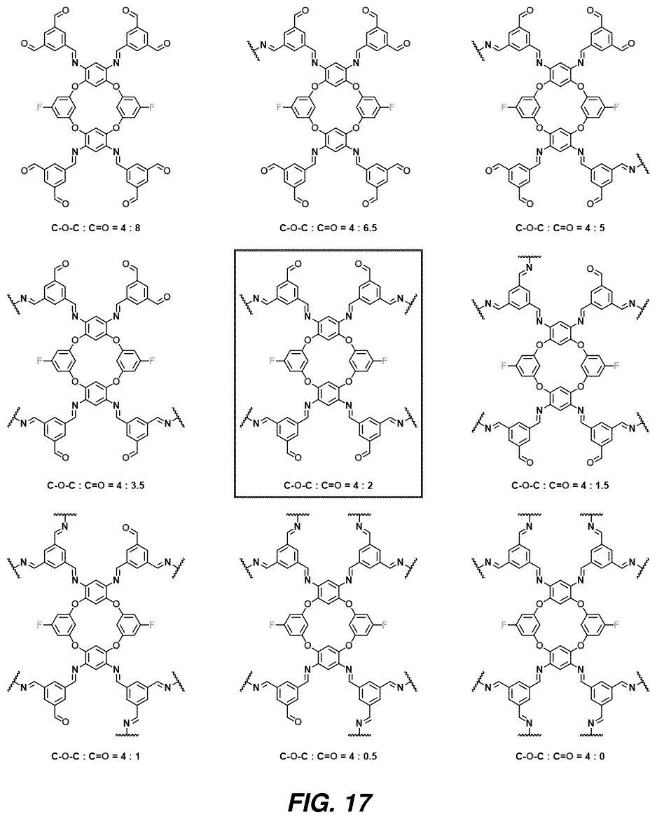

X-ray photoelectron spectroscopy (XPS) was further used to determine the dominant chemical structures present within the crosslinked oxacalix[4]arene-based polyimine ACX-TFB because each calixarene core can condense with multiple triformylbenzene linkers to generate polymer networks. The survey spectrum revealed sharp binding energy peaks corresponding to carbon (C 1s), nitrogen (N 1s), oxygen (O 1s) and fluorine (F 1s), with atomic percentages in line with expected values, which confirmed the elemental composition of the oxacalix[4]arene scaffold in the crosslinked polymer networks. In addition, the high-resolution N 1s peaks of ACX and ICX appeared at binding energies ca. 399.68 eV and ca. 398.88 eV, respectively, and may therefore be assigned to the amine (NH₂) and imine (N═C) moieties, respectively. The high-resolution N 1s spectrum of ACX-TFB contained a peak quite close in binding energy to ICX but varied significantly compared to that of ACX, further suggesting full conversion of all amine to imine moieties during the interfacial polymerization. Moreover, the high-resolution O 1s spectrum of ACX-TFB was deconvoluted into two peaks with binding energy maxima at ca. 533.12 eV and ca. 531.78 eV, with 59.5% and 40.5% integration area, respectively. The latter binding energy was almost identical to that of the high-resolution O 1s peak with binding energy maximum at ca. 531.81 eV of TFB, and was thus assigned to the aldehyde unit. Consequently, the higher binding energy peak of the ACX-TFB O 1s spectrum was assigned to the oxygen atom of diaryl ether (C—O—C) within the oxacalix[4]arene scaffold. Importantly, the chemical structure of ACX-TFB was deduced as crosslinked polyimine networks based on the ratio between oxygen atoms of the diaryl ether units (C—O—C) within an oxacalix[4]arene backbone and of remaining aldehyde units (C═O) from TFB monomer. By listing out possible crosslinking patterns with their corresponding ratio between oxygen atoms of C—O—C and C—O (FIG. 17), it was found that the ACX-TFB structure, also depicted in FIG. 14, with a ratio of 4:2 for C—O—C to C—O, matched closely to the experimentally determined ratio of 4:2.67 from the deconvoluted O 1s peaks, described above. The additional 0.67 oxygen content is believed to likely represent end groups positioned at the edges of the crosslinked polyimine networks.

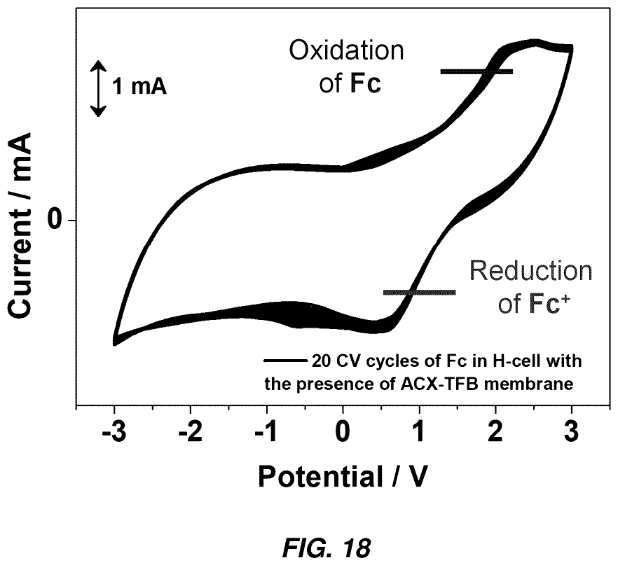

The thermal stability of the model tetraimino-oxacalix[4]arene compound ICX and crosslinked oxacalix[4]arene-based polyimine ACX-TFB was studied using thermogravimetric analysis (TGA) under an inert nitrogen atmosphere. ICX showed a respectable value of thermal decomposition temperature (T_{d}, at 5% weight loss) at ca. 390° C., and the crosslinked polyimine ACX-TFB had a slightly improved thermal stability with the T_{d} at ca. 406° C. Additionally, the electrochemical stability of imine-based materials ICX and ACX-TFB was studied using cyclic voltammetry (CV). The model tetraimine-oxacalix[4]arene compound ICX was easily dissolved in an electrolyte solution of 0.5 M tetraethylammonium tetrafluoroborate (TEABF₄) in acetonitrile (ACN) for CV measurement. ICX displayed the first and the second irreversible oxidation waves at +1.67 and +1.91 V vs. saturated calomel electrode (SCE), and the first quasi-reversible reduction couple at −2.43 V vs. SCE. The first oxidation and reduction was tentatively attributed to π and π*, respectively, of the π-conjugated system along bis-imine groups attached to the oxacalix[4]arene ring. With the design of a battery membrane that should not dissolve in electrolyte solution as one of desired properties, it was observed that the crosslinked polyimine ACX-TFB did dissolve in organic solvents for the cyclic voltammetry (CV) study. The membrane of ACX-TFB was then studied in an H-cell instead of a traditional three-electrode cell. With the ACX-TFB membrane separating two half cells in the H-cell, there were no obvious oxidation and reduction events ranging +3.00 to −3.00 V during twenty CV cycles, suggesting that the ACX-TFB membrane was essentially inert in the H-cell upon applying potentials. Furthermore, ferrocene was introduced as a classical active redox compound in one of the half-cells with the ACX-TFB membrane to examine the electrochemical stability with the presence of electrochemical radicals during multiple CV cycles. Ferrocene displayed obvious anodic current at the oxidation wave, and the new appearance of cathodic current to give a complete oxidation couple indicated the reduction of oxidized ferrocenium back to ferrocene (FIG. 18). There was no significant electrochemical decomposition of ferrocene/ferrocenium redox couple during twenty CV cycles with the presence of ACX-TFB membrane, indicating that the membrane is also inert to the ferrocene/ferrocenium redox couple as one of the most classical active redox compounds.

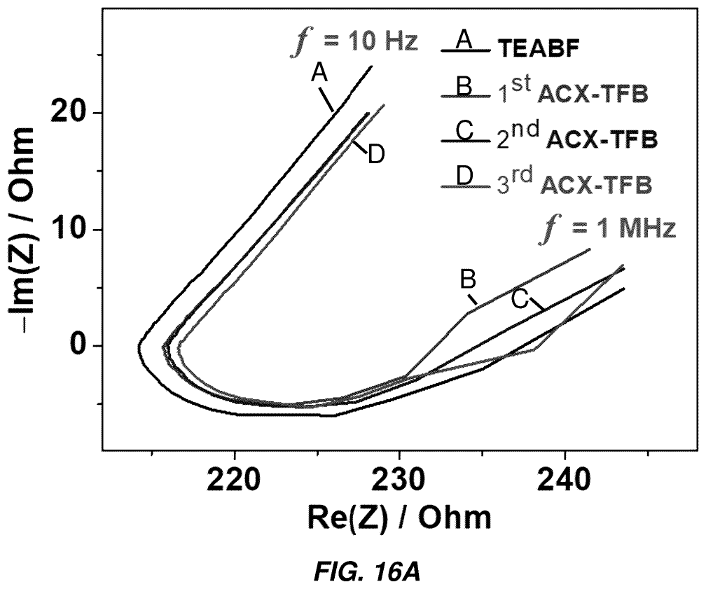

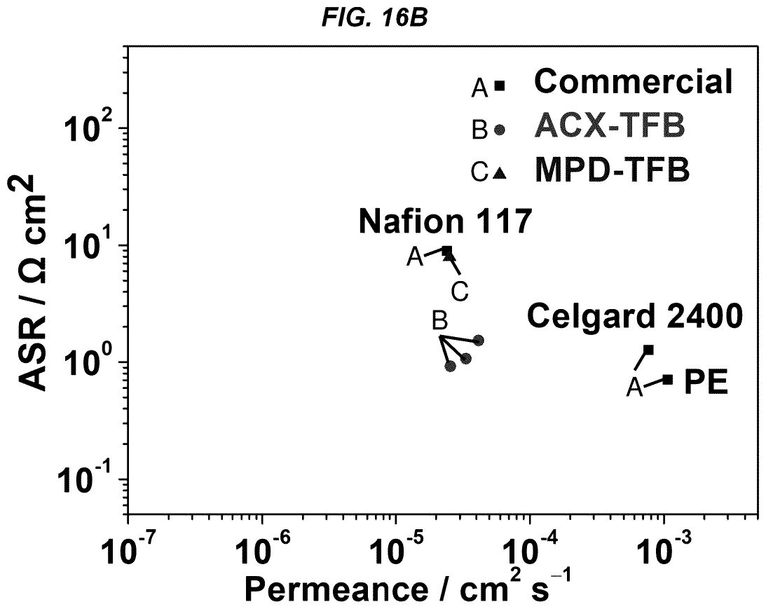

Importantly, it was found that the ACX-TFB membrane displays extra-low area specific resistance (ASR) and permeance against the redox-active species of catholyte, making this example of a crosslinked oxacalix[4]arene-based polyimine a promising candidate for NARFB applications. It is believed that in certain instances, the battery membrane should not only allow the exchange of supporting electrolyte ions to maintain the charge balance and maximize current density, but also act as a separator to block the crossover of positive and negative redox-active species for prevention of self-discharge and irreversible capacity loss. Electrochemical impedance spectroscopy (EIS) was used with alternating current to study ohmic resistance of a conductivity cell with the presence or absence of a polymer membrane. The Nyquist plots of the conductivity H-cell containing electrolyte solution with or without the ACX-TFB membrane were obtained by measuring the impedance at high and low frequency (f) regions ranging from 1.0 MHz to 10 Hz (FIG. 16A), in which the ohmic resistance represented the real part of impedance and entirely dominated expressed as the value of x-intercept. The conductivity H-cell containing electrolyte solution showed its ohmic resistance as 214.26Ω (FIG. 16B). Upon introduction of the ACX-TFB membrane, the H-cell exhibited just slightly higher value of resistance at ca. 215.71-216.67Ω among three different batches of ACX-TFB membrane (FIG. 16A and Table 7), indicating that ACX-TFB membranes showed a consistent and reproducible property of extra-low ohmic resistance down to 1.45Ω.

Upon interfacial polymerization of ACX-TFB on the substrate of polyethylene (PE) to form a polymeric selective layer that is intrinsically porous in submicron size, it was found that this yellow membrane of the crosslinked oxacalix[4]arene-based polyimine ACX-TFB featured an extra-low ASR value at ca. 0.92-1.53 Ωcm² among three different batches, which was comparable to the PE substrate and met the recommended target resistance of <2.3 Ωcm² for NARFB. More importantly, the permeance property of ACX-TFB membrane against the small molecule active redox species of MEEPT was shown to be much reduced from 1.07×10⁻³ cm² s⁻¹ down to 2.55×10⁻⁵ cm² s⁻¹ from PE substrate. Apart from comparing with the PE substrate, the non-oxacalix[4]arene-based polyimine MPD-TFB membrane was also prepared by interfacial polymerization to investigate its ASR and permeance properties. The MPD-TFB membrane showed a similar permeance value of 2.51×10⁻⁵ cm² s⁻¹ against MEEPT but exhibited much higher ASR value of 7.89 Ωcm² when compared to the oxacalix[4]arene-containing polyimine ACX-TFB. The oxacalix[4]arene scaffold, having a nonplanar saddle shape and intrinsic porous cavity, was found to play an important role to preserve extra-low ASR and permeance properties, which is believed to be likely due to efficient exchange of supporting electrolyte ions that maintain ion conductivity of the membrane. Furthermore, it was discovered that this crosslinked oxacalix[4]arene-based polyimine ACX-TFB prepared by interfacial polymerization resulted in the generation of membranes with greatly reduced ASR properties and permeance that vastly exceeded the industry standard membranes under the trade names of Nafion and Celgard (FIG. 16B).

### Materials and Methods

### Materials and Reagents

All reagents are of analytical grade and were used without further purification.

### Synthesis and Characterizations

The tetranitro-oxacalix[4]arene NCX was prepared by the nucleophilic aromatic substitution (S_{N}Ar) macrocyclization reaction of 5-fluorobenzene-1,3-diol and 1,5-difluoro-2,4-dinitrobenzene. Then, the tetraamino-oxacalix[4]arene ACX as the monomer was prepared by a catalytic hydrogenation reaction of NCX. Model compound of tetraimine-oxacalix[4]arene ICX was prepared by imination of ACX with 4-(tert-butyl)benzaldehyde with the presence of an acetic acid. The ¹H, ¹³C{¹H}, ¹⁹F{¹H}, NMR spectra were recorded by a two-channel Bruker (400 MHz) Avance-III HD Nanobay spectrometer or a three-channel Bruker (500 MHz) Avance Neo spectrometer. Chloroform-d (CDCl₃) and dimethylsulfoxide-d₆ (DMSO-d₆) were used as solvents for NMR measurements. Tetramethylsilane (Me₄Si) and the residual solvent of chloroform (CHCl₃) were used as standard for the determination of the chemical shifts (δ, ppm) in the ¹H and ¹³C{¹H} NMR spectroscopy. Unless otherwise specified, the NMR spectra were recorded at room temperature. Direct Analysis in Real Time (DART) mass spectra were recorded on a high-resolution JEOL AccuTOF 4G LC-plus mass spectrometer equipped with an ionSense DART source. Maldi mass spectrum was recorded on a high-resolution MaldiTOF Bruker Autoflex LRF Speed mass spectrometer. Single-crystal X-ray data of ACX were collected at the X-Ray Diffraction Facility of the MIT Department of Chemistry, Massachusetts 02139-4307, United States.

Tetranitro-oxacalix[4]arene NCX. A mixture of 5-fluorobenzene-1,3-diol (5.00 g, 39.0 mmol), 1,5-difluoro-2,4-dinitrobenzene (7.97 g, 39.0 mmol), potassium carbonate (13.5 g, 97.5 mmol) in dimethylsulfoxide (250 ml) was stirred at room temperature for three hours. The reaction mixture was diluted by ethyl acetate (250 mL) and filtration to remove the insoluble solid. Deionized water (250 mL) was used to wash the organic layer three times, which was subsequently dried over anhydrous magnesium sulfate and filtered. The solvent was removed under reduced pressure to dryness. Column chromatography with silica gel (70-230 mesh) was then employed to purify the crude product by using dichloromethane-ethyl acetate mixture as eluent. Recrystallization from a concentrated ethyl acetate solution by layering hexane afforded colorless crystals. Yield: 9.80 g, 16.8 mmol; 86%, ¹H NMR (400 MHz, DMSO-d₆, 298 K, δ/ppm): δ 7.03 (s, 2H, phenyl), 7.17-7.20 (dd, ²J_{HF}=9 Hz, ³J_{HH}=4 Hz, 4H, phenyl), 7.33 (s, 2H, phenyl), 8.94 (s, 2H, phenyl). ¹³C{¹H} NMR (100 MHz, CDCl₃, 298 K, δ/ppm): δ 105.00 (d, ²J_{CF}=25 Hz), 105.05 (d, ⁴J_{CF}=4 Hz), 111.57, 124.40, 135.41, 153.38, 156.49 (d, ³J_{CF}=15 Hz), 163.69 (d, ¹J^{CF}=244 Hz). ¹⁹F{¹H} NMR (377 MHz, CDCl₃, 298 K, δ/ppm): δ −108.20. HRMS (Positive DART) calcd for C₂₄H₁₁F₂N₄O₁₂ m/z=585.03415; found 585.03193 [M+H]⁺.

Tetraamino-oxacalix[4]arene ACX. A mixture of NCX (2.00 g, 3.42 mmol) and 10% palladium on carbon (Pd/C) (342 mg, 100 mg mmol-1) in ethyl acetate-methanol mixture (1:1; 100 ml) was stirred at 60° C. overnight with the presence of hydrogen balloon. After complete reaction, the Pd/C was removed by filtration and the solvent was removed under reduced pressure to dryness. Recrystallization from a concentrated acetone solution by layering hexane afforded colorless crystals. Yield: 1.58 g, 3.41 mmol; quantitative. ¹H NMR (400 MHz, DMSO-d₆, 298 K, δ/ppm): δ 4.60 (s, 8H, —NH₂), 5.78 (s, 2H, phenyl), 6.13 (s, 2H, phenyl), 6.37 (s, 2H, phenyl), 6.58 (d, ²J_{HF}=8 Hz, 4H, phenyl). ¹³C{¹H} NMR (100 MHz, CDCl₃, 298 K, δ/ppm): δ 94.58, 97.76 (d, ²J_{CF}=25 Hz), 102.10, 115.24, 129.47, 138.60, 161.19 (d, ³J_{CF}=15 Hz), 163.45 (d, ¹J_{CF}=240 Hz). ¹⁹F{¹H} NMR (377 MHz, CDCl₃, 298 K, δ/ppm): δ −112.14. FTIR (solid, cm⁻¹): 3358, 3442 (primary amine). HRMS (Positive DART) calcd for C₂₄H₁₉F₂N₄O₄ m/z=465.13744; found 465.13587 [M+H]⁺. CCDC: 2373868.

Tetraimine-oxacalix[4]arene ICX. A mixture of ACX (100 mg, 0.216 mmol), 4-(tert-butyl)benzaldehyde (157 mg, 0.970 mmol) and a catalytic amount of acetic acid in dichloromethane (50 ml) was stirred at room temperature for three hours. The solvent was removed under reduced pressure to dryness. Recrystallization from a concentrated dichloromethane solution by layering hexane afforded yellow solids. Yield: 130 mg, 0.125 mmol; 58%, ¹H NMR (400 MHz, CDCl₃, 298 K, δ/ppm): δ 1.33 (s, 36H, t-Bu), 5.91 (s, 2H, phenyl), 6.57 (dd, ²J_{HF}=9.6 Hz, ³J_{HH}=2.4 Hz, 4H, phenyl), 6.73 (m, 2H, phenyl), 6.92 (m, 2H, phenyl), 7.42 (d, ²J_{HH}=8.4 Hz, 8H, phenyl), 7.74 (d, ²J^{HH}=8.4 Hz, 8H, phenyl), 8.41 (s, 4H, imine). ¹³C{¹H} NMR (100 MHz, DMSO-d₆, 298 K, δ/ppm): δ 30.87 (t-Bu), 34.74 (t-Bu), 96.31, 98.04, 98.30, 113.14, 117.62, 125.54, 128.64, 132.97, 143.56, 143.59, 154.87, 160.82 (d, ³J_{CF}=16 Hz), 162.63 (imine). ¹⁹F{¹H} NMR (377 MHz, CDCl₃, 298 K, δ/ppm): δ −110.41, −110.38, −110.36. FTIR (solid, cm⁻¹): 1606 (imine), 2964 (t-Bu). HRMS (Positive MALDI) calcd for C₆₈H₆₇F₂N₄O₄ m/z=1041.5130; found 1041.4208 [M+H]⁺.

### Physical Measurements and Instrumentation.

Unless otherwise specified, all measurements were conducted at room temperature. A Thermo Scientific Nicolet iS5 spectrometer (iD5 ATR, diamond) was used for Fourier-transform infrared (FTIR) measurements of solid samples. An Agilent Cary 5000 UV-vis spectrophotometer was used for UV-vis absorption measurements. Spectrophotometric grade dichloromethane (DCM) was used as solvent for optical measurements. TGA 5500 from TA Instruments was used for the thermogravimetric analysis (TGA) measurements of solid samples (~3 mg) on the platinum pan. The isotherms were performed from room temperature to 900° C. with the ramp speed of 10° C. min⁻¹ under nitrogen atmosphere (AirGas, ultra-high purity grade). A BioLogic SP-150 potentiostat was used for measurements of cyclic voltammetry (CV) and electrochemical impedance spectroscopy (EIS). Electrochemical properties of model compounds ICX were studied in deaerated 0.5 MⁿEt₄NBF₄ acetonitrile solution using CV. Working electrodes were polished using first 1.0 μm, then 0.05 μm suspensions of alumina in water on a polishing pad. A glassy carbon (CH Instrument) electrode and a Ag/AgNO₃ (0.1 M in acetonitrile) electrode were used as the working electrode and reference electrode, respectively. The counter electrode was a platinum wire. The internal reference was the ferrocenium/ferrocene couple (FeCp₂^{+/0}). The ohmic resistance of PE, ACX-TFB and MPD-TFB membranes were measured in a H-cell containing 0.5 MⁿEt₄NBF₄ acetonitrile solution and two graphite electrodes from low frequency to high frequency (0.1-0.01 Hz) with AC potential by EIS. The membrane is immersed in the electrolyte solution at least for 24 h before measurements. After assembly of a conductivity H-cell, half to one hour is required for the generation of stable Nyquist plots. X-ray photoelectron spectroscopy (XPS) measurements were performed using a Thermo Fisher Scientific K-Alpha⁺ spectrometer equipped with an Al Kα radiation source. XPS data analysis and curve fitting were performed using Thermo Avantage software (v6.6.0).

### Tables Related to Example 2

TABLE 4
Crystal and structure determination data of ACX

| | |
|---|---|
| Compound | ACX |
| Color | colorless |
| Empirical formula | C₂₄H₁₈F₂N₄O₄•2(Me₂CO) |
| Formula weight | 580.58 |
| Temp, K | 100(2) |
| Wavelength, Å | 0.71073 |
| Crystal system | triclinic |
| Space group | P1̅ |
| a, Å | 10.0835(3) |
| b, Å | 11.9204(4) |
| c, Å | 13.5291(5) |
| α, deg | 103.5751(13) |
| β, deg | 107.2403(11) |
| γ, deg | 107.0020(11) |
| Volume, Å³ | 1390.25(8) |
| Z | 2 |
| Density (calcd), g cm⁻³ | 1.387 |
| Index ranges | −14 ≤ h ≤ 13, |
| | −17 ≤ k ≤ 17, |
| | −19 ≤ l ≤ 19 |
| reflections collected | 108848 |
| Independent reflection | 8867 [R(int) = 0.0357] |
| GOF on F2 | 1.045 |
| Final R indices | R₁ = 0.0580, wR₂ = 0.1480 |
| [I > 2σ (l)] | |
| Largest diff. peak and hole, eÅ⁻³ | 1.160 and −0.582 |

TABLE 5
Bond angles [deg] for ACX with estimated
standard deviations given in parentheses

| | | | |
|---|---|---|---|
| C(1)—O(1)—C(35) | 117.16(10) | C(13)—C(14)—N(2) | 119.95(14) |
| C(5)—O(2)—C(11) | 116.86(10) | C(15)—C(14)—N(2) | 121.96(13) |
| C(21)—O(3)—C(15) | 116.76(11) | C(16)—C(15)—O(3) | 119.88(13) |
| C(25)—O(4)—C(31) | 116.59(10) | C(16)—C(15)—C(14) | 121.25(12) |
| C(12)—N(1)—H(1A) | 114.5(14) | O(3)—C(15)—C(14) | 118.86(13) |
| C(12)—N(1)—H(1B) | 111.9(14) | C(11)—C(16)—C(15) | 119.36(12) |
| H(1A)—N(1)—H(1B) | 109.9(17) | C(11)—C(16)—H(16) | 120.3 |
| C(14)—N(2)—H(2A) | 110.5(14) | C(15)—C(16)—H(16) | 120.3 |
| C(14)—N(2)—H(2B) | 112.3(14) | O(3)—C(21)—C(26) | 122.60(12) |
| H(2A)—N(2)—H(2B) | 107.6(17) | O(3)—C(21)—C(22) | 115.44(12) |
| C(32)—N(3)—H(3A) | 113.9(13) | C(26)—C(21)—C(22) | 121.94(12) |
| C(32)—N(3)—H(3B) | 113.1(13) | C(23)—C(22)—C(21) | 116.76(12) |
| H(3A)—N(3)—H(3B) | 109.1(16) | C(23)—C(22)—H(22) | 121.6 |
| C(34)—N(4)—H(4A) | 112.3(14) | C(21)—C(22)—H(22) | 121.6 |
| C(34)—N(4)—H(4B) | 111.7(13) | F(2)—C(23)—C(24) | 117.84(12) |
| H(4A)—N(4)—H(4B) | 110.6(16) | F(2)—C(23)—C(22) | 117.93(12) |
| O(1)—C(1)—C(6) | 122.44(11) | C(24)—C(23)—C(22) | 124.23(13) |
| O(1)—C(1)—C(2) | 115.65(12) | C(23)—C(24)—C(25) | 117.04(12) |
| C(6)—C(1)—C(2) | 121.91(12) | C(23)—C(24)—H(24) | 121.5 |
| C(3)—C(2)—C(1) | 116.56(13) | C(25)—C(24)—H(24) | 121.5 |
| C(3)—C(2)—H(2) | 121.7 | O(4)—C(25)—C(24) | 115.32(11) |
| C(1)—C(2)—H(2) | 121.7 | O(4)—C(25)—C(26) | 122.95(11) |
| F(1)—C(3)—C(2) | 117.40(13) | C(24)—C(25)—C(26) | 121.72(12) |
| F(1)—C(3)—C(4) | 117.90(13) | C(21)—C(26)—C(25) | 118.29(12) |
| C(2)—C(3)—C(4) | 124.69(13) | C(21)—C(26)—H(26) | 120.9 |
| C(3)—C(4)—C(5) | 116.31(12) | C(25)—C(26)—H(26) | 120.9 |
| C(3)—C(4)—H(4) | 121.8 | C(36)—C(31)—O(4) | 119.37(11) |
| C(5)—C(4)—H(4) | 121.8 | C(36)—C(31)—C(32) | 121.29(12) |
| O(2)—C(5)—C(6) | 121.95(12) | O(4)—C(31)—C(32) | 119.34(11) |
| O(2)—C(5)—C(4) | 115.85(11) | C(33)—C(32)—C(31) | 117.67(12) |
| C(6)—C(5)—C(4) | 122.20(13) | C(33)—C(32)—N(3) | 120.61(12) |
| C(1)—C(6)—C(5) | 118.32(12) | C(31)—C(32)—N(3) | 121.70(12) |
| C(1)—C(6)—H(6) | 120.8 | C(34)—C(33)—C(32) | 122.30(12) |
| C(5)—C(6)—H(6) | 120.8 | C(34)—C(33)—H(33) | 118.8 |
| C(16)—C(11)—O(2) | 119.91(12) | C(32)—C(33)—H(33) | 118.8 |
| C(16)—C(11)—C(12) | 121.05(12) | C(33)—C(34)—N(4) | 120.67(12) |
| O(2)—C(11)—C(12) | 119.04(12) | C(33)—C(34)—C(35) | 117.98(12) |
| C(13)—C(12)—N(1) | 120.18(12) | N(4)—C(34)—C(35) | 121.30(12) |
| C(13)—C(12)—C(11) | 118.24(12) | C(36)—C(35)—O(1) | 120.05(12) |
| N(1)—C(12)—C(11) | 121.54(12) | C(36)—C(35)—C(34) | 121.02(12) |
| C(12)—C(13)—C(14) | 122.06(13) | O(1)—C(35)—C(34) | 118.90(12) |
| C(12)—C(13)—H(13) | 119.0 | C(31)—C(36)—C(35) | 119.68(12) |
| C(14)—C(13)—H(13) | 119.0 | C(31)—C(36)—H(36) | 120.2 |
| C(13)—C(14)—C(15) | 118.03(13) | C(35)—C(36)—H(36) | 120.2 |

TABLE 6
Bond lengths [Å] for ACX with estimated
standard deviations given in parentheses

| | | | |
|---|---|---|---|
| F(1)—C(3) | 1.3579(16) | C(4)—H(4) | 0.9500 |
| F(2)—C(23) | 1.3551(15) | C(5)—C(6) | 1.3885(17) |
| O(1)—C(1) | 1.3799(15) | C(6)—H(6) | 0.9500 |
| O(1)—C(35) | 1.3953(15) | C(11)—C(16) | 1.3851(18) |
| O(2)—C(5) | 1.3831(16) | C(11)—C(12) | 1.3992(18) |
| O(2)—C(11) | 1.3972(16) | C(12)—C(13) | 1.3904(19) |
| O(3)—C(21) | 1.3837(16) | C(13)—C(14) | 1.392(2) |
| O(3)—C(15) | 1.3944(16) | C(13)—H(13) | 0.9500 |
| O(4)—C(25) | 1.3834(15) | C(14)—C(15) | 1.397(2) |
| O(4)—C(31) | 1.3979(15) | C(15)—C(16) | 1.3878(19) |
| N(1)—C(12) | 1.3968(17) | C(16)—H(16) | 0.9500 |
| N(1)—H(1A) | 0.907(14) | C(21)—C(26) | 1.3913(18) |
| N(1)—H(1B) | 0.903(14) | C(21)—C(22) | 1.3924(18) |
| N(2)—C(14) | 1.4014(18) | C(22)—C(23) | 1.3808(19) |
| N(2)—H(2A) | 0.934(15) | C(22)—H(22) | 0.9500 |
| N(2)—H(2B) | 0.926(15) | C(23)—C(24) | 1.3790(19) |
| N(3)—C(32) | 1.4061(16) | C(24)—C(25) | 1.3903(18) |
| N(3)—H(3A) | 0.903(14) | C(24)—H(24) | 0.9500 |
| N(3)—H(3B) | 0.906(14) | C(25)—C(26) | 1.3945(17) |
| N(4)—C(34) | 1.3983(17) | C(26)—H(26) | 0.9500 |
| N(4)—H(4A) | 0.890(14) | C(31)—C(36) | 1.3851(18) |
| N(4)—H(4B) | 0.912(14) | C(31)—C(32) | 1.3993(17) |
| C(1)—C(6) | 1.3883(18) | C(32)—C(33) | 1.3970(18) |
| C(1)—C(2) | 1.3918(18) | C(33)—C(34) | 1.3949(18) |
| C(2)—C(3) | 1.378(2) | C(33)—H(33) | 0.9500 |
| C(2)—H(2) | 0.9500 | C(34)—C(35) | 1.3986(18) |
| C(3)—C(4) | 1.380(2) | C(35)—C(36) | 1.3862(18) |
| C(4)—C(5) | 1.3902(18) | C(36)—H(36) | 0.9500 |

TABLE 7
Area-specific resistance (ASR) and permeance data of crosslinked
oxacalix[4]arene-based polyimine-deposited PE membranes.

| | Ohmic | Area-Specific | |
|---|---|---|---|
| The Separator in the | Resistance^{a} | Resistance^{a, b} | Permeance^{c} |
| Conductivity H-cell | [Z(Re)] (Ω) | (Ωcm²) | (×10⁻⁴ cm²s⁻¹) |
| Blank | 214.26 | — | — |
| 1^{st} ACX-TFB- | 215.71 | 0.92 | 0.256 |
| deposited PE | | | |
| 2^{nd} ACX-TFB- | 215.95 | 1.07 | 0.334 |
| deposited PE | | | |
| 3^{rd} ACX-TFB- | 216.67 | 1.53 | 0.415 |
| deposited PE | | | |

^{a}In ACN with 0.5M TEABF as supporting electrolyte.
^{b}The membrane separator positioned between the H-cell compartments has an area of 0.636 cm².
^{c}The donor chamber filled with 10-[2(2[Methoxyethoxy)ethyl]-10H-phenothiazine (MEEPT) in ACN with 0.1M TEABF, and the acceptor chamber filled with ACN with 0.2M TEABF to match the osmotic balance.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

As used herein in the specification and in the claims, the phrases “at least a portion” or “at least some of” means some or all. “At least a portion” or “at least some of” may mean, in accordance with certain embodiments, at least 1 wt %, at least 2 wt %, at least 5 wt %, at least 10 wt %, at least 25 wt %, at least 50 wt %, at least 75 wt %, at least 90 wt %, at least 95 wt %, or at least 99 wt %, and/or, in certain embodiments, up to 100 wt %.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Unless clearly indicated to the contrary, concentrations and percentages described herein are on a mass basis.

As used herein, “wt %” is an abbreviation of weight percentage. As used herein, “at %” is an abbreviation of atomic percentage.

Some embodiments may be embodied as a method, of which various examples have been described. The acts performed as part of the methods may be ordered in any suitable way. Accordingly, embodiments may be constructed in which acts are performed in an order different than illustrated, which may include different (e.g., more or less) acts than those that are described, and/or that may involve performing some acts simultaneously, even though the acts are shown as being performed sequentially in the embodiments specifically described above.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A membrane, comprising a cross-linked polymeric network comprising a repeat unit derived from a monomer having a three-dimensional structure, wherein the polymeric network has a BET surface area of at least 50 m²/g.

2. The membrane of claim 1, wherein the polymeric network comprises linkages, wherein at least some of the linkages are nitrogen-containing linkages.

3. The membrane of claim 1, wherein the polymeric network comprises a polyamide, a polyimine, and/or a polyamine.

4. The membrane of claim 1, wherein the polymeric network comprises a polyamide and/or a polyimine.

5. The membrane of claim 1, wherein the polymeric network comprises a polyimine.

6. The membrane of claim 1, wherein at least portion of the polymeric network has intrinsic porosity.

7. The membrane of claim 1, wherein the monomer having a three-dimensional structure comprises a non-planar fused bicyclic structure having [2.2.2] or a [2.2.1] ring structure, a triptycene, an iptycene, a calixarene, an adamantane, a tetra-arylmethane, a spiro-arene, and/or a spiro-bisfluorene.

8. The membrane of claim 1, wherein the monomer having a three-dimensional structure comprises a calixarene.

9. The membrane of claim 1, wherein the membrane comprises:
a porous support layer; and
a polymeric selective layer adjacent to the porous support layer, the polymeric selective layer comprising the cross-linked polymeric network.

10. An electrochemical system, comprising:
a cathode compartment comprising a first liquid solution;
an anode compartment comprising a second liquid solution; and
the membrane of claim 1 separating the cathode compartment and the anode compartment.

11. The electrochemical system of claim 10, wherein the first liquid solution is a first nonaqueous liquid solution and the second liquid solution is a second nonaqueous liquid solution.

12. An electrochemical system, comprising:
a cathode compartment comprising a first nonaqueous liquid solution;
an anode compartment comprising a second nonaqueous liquid solution; and
a membrane separating the cathode compartment and the anode compartment, the membrane comprising:
a porous support layer; and
a polymeric selective layer adjacent to the porous support layer, the polymeric selective layer comprising a polymeric network comprising a repeat unit derived from a monomer having a three-dimensional structure and having an average thickness of less than or equal to 1 micron.

13. The electrochemical system of claim 12, wherein the polymeric network comprises linkages, wherein at least some of the linkages are nitrogen-containing linkages.

14. The electrochemical system of claim 12, wherein the polymeric network comprises a polyamide, a polyimine, and/or a polyamine.

15. The electrochemical system of claim 12, wherein the polymeric network is cross-linked and comprises a polyamide and/or a polyimine.

16. The electrochemical system of claim 12, wherein the polymeric network comprises a polyimine.

17. The electrochemical system of claim 12, wherein at least portion of the polymeric network has intrinsic porosity.

18. The electrochemical system of claim 12, wherein the monomer having a three-dimensional structure comprises a non-planar fused bicyclic structure having [2.2.2] or a [2.2.1] ring structure, a triptycene, an iptycene, a calixarene, an adamantane, a tetra-arylmethane, a spiro-arene, and/or a spiro-bisfluorene.

19. The electrochemical system of claim 12, wherein the monomer having a three-dimensional structure comprises a calixarene.

20. The electrochemical system of claim 12, wherein the first nonaqueous liquid solution has the same liquid composition as the second nonaqueous liquid solution.

21. A method, comprising charging and/or discharging the electrochemical system of claim 12.
